(19) United States
(12) Patent Application Publication
(10) Pub. No.: US 2023/0204968 A1
(43) Pub. Date: Jun. 29, 2023

(54) IMAGE DISPLAY UNIT AND HEAD-MOUNTED DISPLAY

(71) Applicant: FUJIFILM Corporation, Tokyo (JP)

(72) Inventors: Hiroshi SATO, Minamiashigara-shi (JP); Yukito Saitoh, Minamiashigara-shi (JP); Takashi Yonemoto, Minamiashigara-shi (JP)

(73) Assignee: FUJIFILM Corporation, Tokyo (JP)

(21) Appl. No.: 18/172,807

(22) Filed: Feb. 22, 2023

Related U.S. Application Data
(63) Continuation of application No. PCT/JP21/31091, filed on Aug. 25, 2021.

(30) Foreign Application Priority Data
Aug. 26, 2020 (JP) 2020-142442
Oct. 22, 2020 (JP) 2020-177206

(51) Int. Cl. G02B 27/28; G02B 27/42; G02B 5/30; G06F 1/16

(52) U.S. Cl. CPC G02B 27/281; G02B 27/4205; G02B 5/3016; G06F 1/163; G02B 5/3083

(57) ABSTRACT

Provided are an image display unit and a head-mounted display where the size is small, the light utilization efficiency is high, and a decrease in image quality is small. The image display unit includes: an image display apparatus; a polarization diffraction element that diffracts light emitted from the image display apparatus; and a polarizing plate that allows transmission of the polarized light diffracted by the polarization diffraction element and absorbs light not diffracted by the polarization diffraction element, in which the polarization diffraction element is a polarization diffraction lens having a lens function, and in a case where a focal length of the polarization diffraction lens is represented by f and a distance between the image display apparatus and the polarization diffraction lens is represented by d, d≤f is satisfied.

### CROSS-REFERENCE TO RELATED APPLICATIONS

This application is a Continuation of PCT International Application No. PCT/JP2021/031091 filed on Aug. 25, 2021, which claims priority under 35 U.S.C. § 119(a) to Japanese Patent Application No. 2020-142442 filed on Aug. 26, 2020 and Japanese Patent Application No. 2020-177206 filed on Oct. 22, 2020. The above applications are hereby expressly incorporated by reference, in its entirety, into the present application.

### BACKGROUND OF THE INVENTION

### 1. Field of the Invention

The present invention relates to an image display unit that is used in a head-mounted display for virtual reality (VR) and a head-mounted display.

### 2. Description of the Related Art

In order for a user to experience so-called immersive virtual reality (VR) that does not allow transmission of external light in the real world, a head-mounted display including an image display unit that is worn by the user and guides an image to the eyes of the user is used. In the image display unit used for the head-mounted display, a lens that focuses light emitted from an image display apparatus on positions of the eyes of the user is necessary. In the image display unit used for the head-mounted display, by setting the distance between the image display apparatus and the lens to be similar to a focal length of the lens, an image that is displayed to the user by the image display apparatus can be visually recognized as a distant virtual image.

In the image display unit used for the head-mounted display, in general, a Fresnel lens is used as the lens for reduction in thickness and weight. However, in a case where the Fresnel lens is used, there is a limit in reducing the focal length. Therefore, it is difficult to reduce the entire thickness of the image display unit (head-mounted display).

On the other hand, as a configuration for reducing the thickness of the image display unit, there is proposed a structure where light emitted from an image display apparatus is reflected once from a reflective polarizer or the like and is reflected again using a mirror or the like to guide the light to the eyes of the user. As a result, an optical path length from the image display apparatus to the eyes of the user can be obtained, and the total thickness of the image display unit can be reduced.

For example, JP2019-526075A describes a head-mounted display that includes a linear polarizer, a ¼ wave plate, a half mirror, a ¼ wave plate, and a reflective polarizer in this order from an image display apparatus side and can be used as an optical device for VR. In this optical element, light is reciprocated between the half mirror and the reflective polarizer to increase the optical path length.

### SUMMARY OF THE INVENTION

As described above, in the image display unit where the half mirror and the reflective polarizer are used such that light is reciprocated between the half mirror and the reflective polarizer to increase the optical path length, the half mirror allows transmission of about 50% of incident light and reflects about 50% of light transmitted through the half mirror and reflected from the reflective polarizer such that the light is emitted from the image display unit. Therefore, there is a problem in that the light utilization efficiency decreases to about 25% with respect to the amount of light of an image emitted from the image display apparatus.

In addition, in the image display unit including the Fresnel lens, in a case where the focal length is reduced, there is a problem in that scattering caused by a groove structure of the Fresnel lens occurs or that light streak caused by the groove structure is visually recognized, which leads to a problem of a decrease in image quality.

An object of the present invention is to provide an image display unit and a head-mounted display where the size is small, the light utilization efficiency is high, and a decrease in image quality is small.

In order to achieve the object, the present invention has the following configurations.

[1] An image display unit comprising:

an image display apparatus;

a polarization diffraction element that diffracts light emitted from the image display apparatus; and

a polarizing plate that allows transmission of the polarized light diffracted by the polarization diffraction element and absorbs light not diffracted by the polarization diffraction element,

in which the polarization diffraction element is a polarization diffraction lens having a lens function, and

in a case where a focal length of the polarization diffraction lens is represented by f and a distance between the image display apparatus and the polarization diffraction lens is represented by d, d≤f is satisfied.

[2] The image display unit according to [1],

in which the focal length f of the polarization diffraction lens is less than 40 mm.

[3] The image display unit according to [1] or [2],

in which the polarization diffraction element diffracts circularly polarized light, and the polarizing plate is a circularly polarizing plate.

[4] The image display unit according to [3],

in which the image display apparatus emits linearly polarized light, and

a retardation plate is provided between the image display apparatus and the polarization diffraction element.

[5] The image display unit according to [4],

in which the retardation plate is a λ/4 plate.

[6] The image display unit according to [3],

wherein the image display apparatus emits unpolarized light, and

the circularly polarizing plate is provided between the image display apparatus and the polarization diffraction element.

[7] The image display unit according to any one of [3] to [6],

in which the circularly polarizing plate consists of a linearly polarizing plate and a retardation plate.

[8] The image display unit according to [7],

in which the retardation plate is a λ/4 plate.

[9] The image display unit according to any one of [1] to [8],

in which the polarization diffraction element is a liquid crystal diffraction element that includes a liquid crystal layer including a liquid crystal compound,

the liquid crystal layer has a liquid crystal alignment pattern in which a direction of an optical axis derived from the liquid crystal compound changes while continuously rotating in at least one in-plane direction, and

in a case where a length over which the direction of the optical axis derived from the liquid crystal compound in the liquid crystal alignment pattern rotates by 180° in an in-plane direction is set as a single period, the liquid crystal layer has regions where lengths of the single periods are different from each other in a plane.

[10] The image display unit according to [9],

in which in the liquid crystal layer, the single period gradually decreases in a direction from one side to another side of the liquid crystal alignment pattern in the one in-plane direction.

[11] The image display unit according to [9] or [10],

in which the liquid crystal layer has a concentric circular shape in which the one in-plane direction of the liquid crystal alignment pattern moves from an inner side toward an outer side.

[12] The image display unit according to any one of [9] to [11],

in which in a cross sectional image obtained by observing a cross section of the liquid crystal layer taken in a thickness direction parallel to the one in-plane direction with a scanning electron microscope, the liquid crystal layer has regions where bright portions and dark portions derived from a liquid crystal phase are tilted with respect to a main surface of the liquid crystal layer.

[13] The image display unit according to [12],

in which the liquid crystal diffraction element includes two or more liquid crystal layers, in cross sectional images obtained by observing cross sections of at least two of the liquid crystal layers taken in a thickness direction parallel to the one in-plane direction with a scanning electron microscope, bright portions and dark portions derived from the direction of the optical axis are observed, and

in the at least two liquid crystal layers, tilt angles of the bright portions and the dark portions with respect to the main surface of the liquid crystal layer are different from each other.

[14] The image display unit according to any one of [9] to [13],

in which in a cross sectional image obtained by observing a cross section of the liquid crystal layer taken in a thickness direction parallel to the one in-plane direction with a scanning electron microscope, the liquid crystal layer has bright portions and dark portions extending from one surface to another surface and each of the dark portions has two or more inflection points of angle, and

the liquid crystal layer has regions where tilt directions of the dark portions are different from each other in the thickness direction.

[15] The image display unit according to [14],

in which in the liquid crystal layer, the number of inflection points where the tilt direction of the dark portion is folded is an odd number.

[16] The image display unit according to any one of [12] to [15],

in which in the liquid crystal layer, an average tilt angle of the dark portion gradually changes in the one in-plane direction.

[17] The image display unit according to any one of [12] to [16],

in which the liquid crystal layer has a region where shapes of the bright portions and the dark portions are asymmetrical with respect to a center line of the liquid crystal layer in the thickness direction.

[18] The image display unit according to any one of [9] to [17],

in which a difference Δn₅₅₀ in refractive index generated by refractive index anisotropy of the liquid crystal layer is 0.2 or more.

[19] A head-mounted display comprising:

the image display unit according to any one of [1] to [18].

According to the present invention, it is possible to provide an image display unit and a head-mounted display where the size is small, the light utilization efficiency is high, and a decrease in image quality is small.

### BRIEF DESCRIPTION OF THE DRAWINGS

FIG. 1 is a diagram conceptually showing an example of an image display unit according to the present invention.

FIG. 2 is an enlarged view showing a part of the image display unit of FIG. 1.

FIG. 3 is a conceptual diagram showing an action of the image display unit of FIG. 1.

FIG. 4 is a partially enlarged view conceptually showing another example of the image display unit according to the present invention.

FIG. 5 is a plan view conceptually showing an example of a liquid crystal layer of a liquid crystal diffraction element.

FIG. 6 is a diagram conceptually showing the liquid crystal layer of the liquid crystal diffraction element shown in FIG. 5.

FIG. 7 is an enlarged plan view conceptually showing a part of the liquid crystal layer of the liquid crystal diffraction element shown in FIG. 5.

FIG. 8 is a diagram conceptually showing one example of an exposure device that exposes an alignment film forming the liquid crystal layer shown in FIG. 5.

FIG. 9 is a conceptual diagram showing an action of the liquid crystal layer.

FIG. 10 is a conceptual diagram showing the action of the liquid crystal layer.

FIG. 11 is a conceptual diagram showing an action of the liquid crystal diffraction element shown in FIG. 5.

FIG. 12 is a diagram conceptually showing an example of an SEM cross section of the liquid crystal layer.

FIG. 13 is a conceptual diagram showing another example of the liquid crystal layer.

FIG. 14 is a conceptual diagram showing another example of the liquid crystal layer.

### DESCRIPTION OF THE PREFERRED EMBODIMENTS

Hereinafter, the details of the present invention will be described. The following description regarding components has been made based on a representative embodiment of the present invention. However, the present invention is not limited to the embodiment. In the present specification, numerical ranges represented by “to” include numerical values before and after “to” as lower limit values and upper limit values. In addition, “perpendicular” or “parallel” regarding an angle represents a range of the exact angle±10°, and “the same” and “different” regarding angles can be determined based on whether or not a difference between the angles is less than 5°.

In the present specification, “slow axis” represents a direction in which a refractive index in a plane is the maximum.

In the present specification, reverse wavelength dispersibility refers to a property in which an absolute value of an in-plane retardation increases as the wavelength increases, and specifically represents that Re(450) as an in-plane retardation value measured at a wavelength of 450 nm, Re(550) as an in-plane retardation value measured at a wavelength of 550 nm, and Re(650) as an in-plane retardation value measured at a wavelength of 650 nm satisfy a relationship of Re(450)≤Re(550)≤Re(650).

[Image Display Unit]

An image display unit according to an embodiment of the present invention comprises:

an image display apparatus;

a polarization diffraction element that diffracts light emitted from the image display apparatus; and

a polarizing plate that allows transmission of the polarized light diffracted by the polarization diffraction element and absorbs light not diffracted by the polarization diffraction element,

in which the polarization diffraction element is a polarization diffraction lens having a lens function, and

in a case where a focal length of the polarization diffraction lens is represented by f and a distance between the image display apparatus and the polarization diffraction lens is represented by d,

d≤f is satisfied.

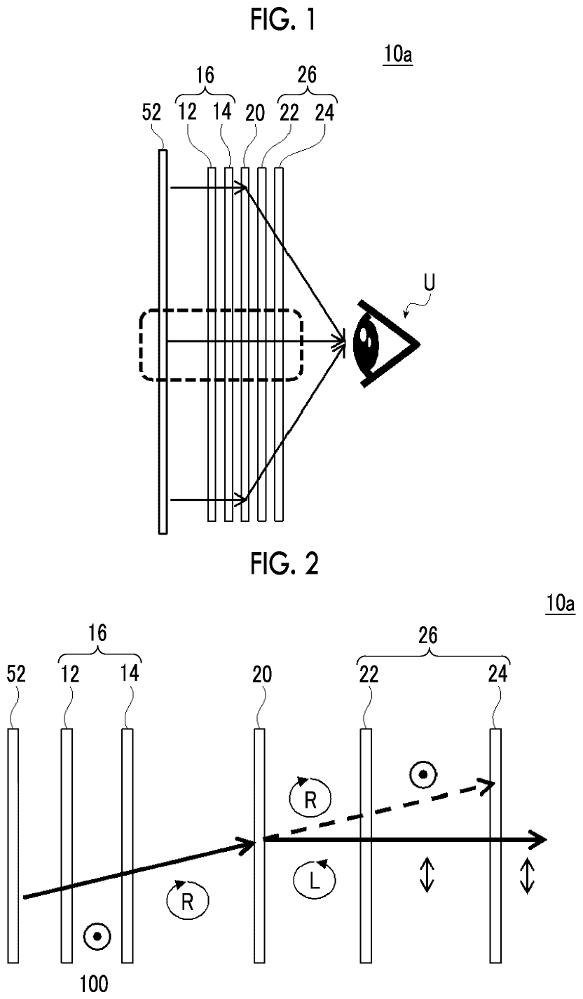

FIG. 1 is a diagram conceptually showing an example of the image display unit according to the embodiment of the present invention. FIG. 2 is an enlarged view showing a part (portion surrounded by a broken line) of the image display unit shown in FIG. 1 and shows an action of the image display unit.

An image display unit 10 shown in FIGS. 1 and 2 includes an image display apparatus 52, a first circularly polarizing plate 16, a polarization diffraction element 20, and a second circularly polarizing plate 26. The first circularly polarizing plate 16 includes a first linearly polarizing plate 12 and a first retardation plate 14. In addition, the second circularly polarizing plate 26 includes a second linearly polarizing plate 24 and a second retardation plate 22. The second circularly polarizing plate 26 is the polarizing plate according to the embodiment of the present invention.

In the example shown in FIG. 1, the image display apparatus 52 emits unpolarized light as an image. In addition, the first circularly polarizing plate 16 allows transmission of circularly polarized light having a predetermined turning direction and cuts the other circularly polarized light. In the example shown in FIG. 1, the first circularly polarizing plate 16 allows transmission of a predetermined linearly polarized light component in incident light using the first linearly polarizing plate 12 and converts linearly polarized light transmitted through first linearly polarizing plate 12 into circularly polarized light having a predetermined turning direction using the first retardation plate 14 to allow transmission of the circularly polarized light. In addition, the polarization diffraction element 20 diffracts the circularly polarized light transmitted through the first circularly polarizing plate 16. In this case, the polarization diffraction element 20 converts the circularly polarized light into circularly polarized light having an opposite turning direction during the conversion of the circularly polarized light. In addition, the polarization diffraction element 20 is a polarization diffraction lens having a lens function of diffracting circularly polarized light to focus the light. The second circularly polarizing plate 26 allows transmission of the light diffracted by the polarization diffraction element 20 and absorbs light not diffracted by the polarization diffraction element 20. In the example shown in FIG. 1, the second circularly polarizing plate 26 converts circularly polarized light diffracted by the polarization diffraction element 20 into linearly polarized light using the second retardation plate 22, allows transmission of the linearly polarized light converted by the second retardation plate 22 using the second linearly polarizing plate 24, and absorbs the other linearly polarized light component. As a result, the second circularly polarizing plate 26 allows transmission of the polarized light diffracted by the polarization diffraction element 20 and absorbs light not diffracted by the polarization diffraction element 20.

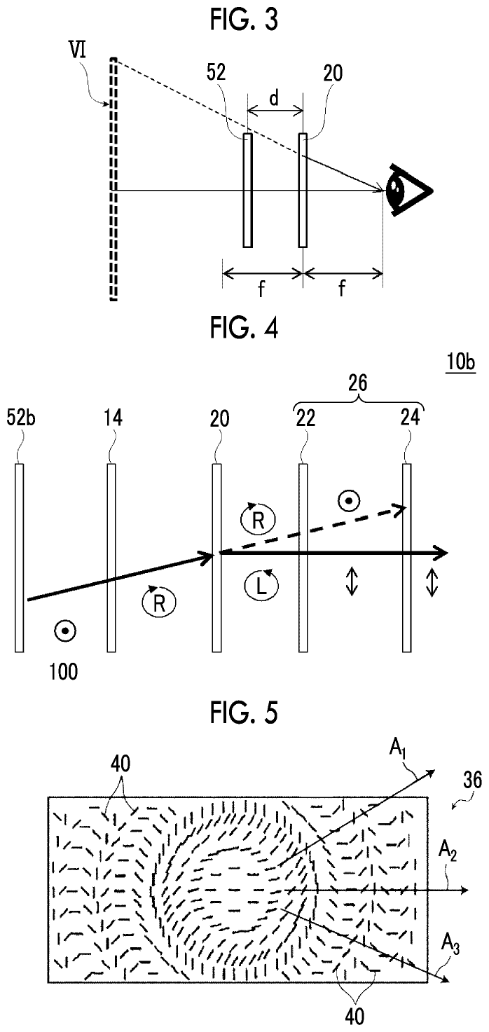

In addition, as shown in FIG. 3, in a case where a focal length of the polarization diffraction element (polarization diffraction lens) 20 is represented by f and a distance between the image display apparatus 52 and the polarization diffraction element 20 is represented by d, the polarization diffraction element 20 and the image display apparatus 52 are disposed to satisfy d≤f.

In the image display unit 10, in a case where the image display apparatus 52 emits light (image), the light transmits through the first circularly polarizing plate 16, the polarization diffraction element 20, and the second circularly polarizing plate 26 and is emitted to a user U. In this case, the light emitted from the image display apparatus 52 is focused on positions of the eyes of the user U by the polarization diffraction element 20. As shown in FIG. 3, in a case where the distance d between the polarization diffraction element 20 and the image display apparatus 52 is less than or equal to the focal length f of the polarization diffraction element 20, the image display unit 10 allows the user U to visually recognize the image as a distant virtual image VI.

Hereinafter, the action of each of the members will be described in detail using FIG. 2. As shown in FIG. 2, in the unpolarized light emitted from the image display apparatus 52, only a predetermined linearly polarized light component transmits through the first linearly polarizing plate 12. For example, in the example shown in FIG. 2, the first linearly polarizing plate 12 allows transmission of a linearly polarized light component perpendicular to the paper plane of FIG. 2. The linearly polarized light transmitted through the first linearly polarizing plate 12 is incident into the first retardation plate 14 and is converted into right circularly polarized light. The right circularly polarized light converted by the first retardation plate 14 is incident into the polarization diffraction element 20 and is diffracted. In addition, during the diffraction, the right circularly polarized light is converted into left circularly polarized light. The left circularly polarized light diffracted by the polarization diffraction element 20 is converted into linearly polarized light in the up-down direction in the drawing by the second retardation plate 22. The linearly polarized light converted by the second retardation plate 22 transmits through the second linearly polarizing plate 24 and is emitted.

Here, the diffraction efficiency of the polarization diffraction element 20 is not likely to be 100%. Therefore, as indicated by an arrow of a broken line in FIG. 2, a part of the right circularly polarized light incident into the polarization diffraction element 20 transmits through the polarization diffraction element 20 without being diffracted. In a case where the second circularly polarizing plate 26 is not provided, the right circularly polarized light not diffracted by the polarization diffraction element 20 is emitted from the image display unit 10 and is visually recognized by the user U. The image by the right circularly polarized light is not focused, and thus is visually recognized as a real image. Therefore, the user U visually recognizes the real image in a state where the real image is superimposed on the virtual image, and thus the image quality of the virtual image to be displayed decreases.

On the other hand, the image display unit 10 according to the embodiment of the present invention includes the second circularly polarizing plate 26. In this case, as shown in FIG. 2, the right circularly polarized light (that is, zero-order light) not diffracted by the polarization diffraction element 20 is incident into the second retardation plate 22 of the second circularly polarizing plate 26, is converted into linearly polarized light having a direction perpendicular to the paper plane of FIG. 2, and is incident into the second linearly polarizing plate 24 and absorbed. That is, the right circularly polarized light not diffracted by the polarization diffraction element 20 is absorbed by the second circularly polarizing plate 26. Accordingly, the user U only visually recognizes only the virtual image by the left circularly polarized light and cannot visually recognize the right circularly polarized light that is not diffracted. Therefore, a decrease in the image quality of the virtual image to be displayed by the image display unit 10 can be suppressed.

In addition, as described above, in the image display unit including the Fresnel lens, in a case where the focal length is reduced, there is a problem in that scattering caused by a groove structure of the Fresnel lens occurs or that light streak caused by the groove structure is visually recognized.

On the other hand, in the image display unit 10 according to the embodiment of the present invention, the polarization diffraction element 20 that diffracts polarized light is used as the lens. Therefore, the polarization diffraction element 20 does not have a groove structure. Therefore, scattering, light streak, and the like caused by the groove structure do not occur, and a decrease in image quality caused by the scattering, the light streak, and the like does not also occur.

In addition, as described above, in the image display unit where the half mirror and the reflective polarizer are used such that light is reciprocated between the half mirror and the reflective polarizer to increase the optical path length, the half mirror allows transmission of about 50% of incident light and reflects about 50% of light transmitted through the half mirror and reflected from the reflective polarizer such that the light is emitted from the image display unit. Therefore, the image display unit has a problem in that the light utilization efficiency decreases to about 25% with respect to the amount of light of an image emitted from the image display apparatus.

On the other hand, in the image display unit 10 according to the embodiment of the present invention, the polarization diffraction element 20 that diffracts polarized light is used as the lens. Therefore, the light utilization efficiency further increases with respect to the amount of light of an image emitted from the image display apparatus 52.

Here, in the example shown in FIG. 1, the image display apparatus 52 emits unpolarized light, and the first circularly polarizing plate 16 is provided between the image display apparatus 52 and the polarization diffraction element 20. However, the present invention is not limited to this configuration.

FIG. 3 is a partially enlarged view conceptually showing another example of the image display unit according to the embodiment of the present invention.

An image display unit 10b shown in FIG. 3 includes an image display apparatus 52b, the first retardation plate 14, the polarization diffraction element 20, and the second circularly polarizing plate 26. The second circularly polarizing plate 26 includes the second linearly polarizing plate 24 and the second retardation plate 22. The second circularly polarizing plate 26 is the polarizing plate according to the embodiment of the present invention.

In the example shown in FIG. 3, the image display apparatus 52b emits linearly polarized light as an image. In addition, the first retardation plate 14 converts the linearly polarized light emitted from the image display apparatus 52b into circularly polarized light. The polarization diffraction element 20 and the second circularly polarizing plate 26 have the same configurations as the polarization diffraction element 20 and the second circularly polarizing plate 26 of the image display unit 10 shown in FIG. 1. In addition, the polarization diffraction element 20 and the image display apparatus 52 are disposed to satisfy d≤f.

In the image display unit 10b, in a case where the image display apparatus 52b emits linearly polarized light (image), the light transmits through the first retardation plate 14, the polarization diffraction element 20, and the second circularly polarizing plate 26 and is emitted to a user U. In this case, the light emitted from the image display apparatus 52b is focused on positions of the eyes of the user U by the polarization diffraction element 20. The distance d between the polarization diffraction element 20 and the image display apparatus 52b is less than or equal to the focal length f of the polarization diffraction element 20. Therefore, the image display unit 10b allows the user U to visually recognize the image as a distant virtual image.

For example, in the example shown in FIG. 3, the image display apparatus 52b emits linearly polarized light having a direction perpendicular to the paper plane of FIG. 3. The linearly polarized light emitted from the image display apparatus 52b is incident into the first retardation plate 14 and is converted into right circularly polarized light. The right circularly polarized light converted by the first retardation plate 14 is incident into the polarization diffraction element 20 and is diffracted. In addition, during the diffraction, the right circularly polarized light is converted into left circularly polarized light. The left circularly polarized light diffracted by the polarization diffraction element 20 is converted into linearly polarized light in the up-down direction in the drawing by the second retardation plate 22. The linearly polarized light converted by the second retardation plate 22 transmits through the second linearly polarizing plate 24 and is emitted.

In addition, the right circularly polarized light (that is, zero-order light) not diffracted by the polarization diffraction element 20 is incident into the second retardation plate 22 of the second circularly polarizing plate 26, is converted into linearly polarized light having a direction perpendicular to the paper plane of FIG. 4, and is incident into the second linearly polarizing plate 24 and absorbed. That is, the right circularly polarized light not diffracted by the polarization diffraction element 20 is absorbed by the second circularly polarizing plate 26. Accordingly, the user U only visually recognizes only the virtual image by the left circularly polarized light and cannot visually recognize the right circularly polarized light that is not diffracted. Therefore, a decrease in the image quality of the virtual image to be displayed by the image display unit 10 can be suppressed.

Here, in the example shown in FIGS. 2 and 4, the polarization diffraction element 20 diffracts circularly polarized light. However, the present invention is not limited to this configuration. For example, the polarization diffraction element may be a polarization diffraction lens that diffracts linearly polarized light. In a case where the polarization diffraction element is a polarization diffraction lens that diffracts linearly polarized light, a linearly polarizing plate that allows transmission of the linearly polarized light diffracted by the polarization diffraction element and absorbs linearly polarized light not diffracted by the polarization diffraction element may be disposed instead of the second circularly polarizing plate 26. With this configuration, the linearly polarizing plate corresponds to the polarizing plate in the present invention.

In addition, in a case where the polarization diffraction element is a polarization diffraction lens that diffracts linearly polarized light, in a case where the image display apparatus emits unpolarized light, the linearly polarizing plate may be disposed between the image display apparatus and the polarization diffraction element, and in a case where the image display apparatus emits linearly polarized light, the linearly polarizing plate, the retardation plate, and the like do not need to be disposed between the image display apparatus and the polarization diffraction element.

In addition, in the examples shown in FIGS. 2 and 4, from the viewpoint of converting incident linearly polarized light into circularly polarized light, it is preferable that the first retardation plate 14 is a λ/4 plate. Basically, the image display apparatus emits visible light. Therefore, the first retardation plate 14 only needs to be a λ/4 plate with respect to the wavelengths of the visible range. In addition, for example, in a case where light incident into the first retardation plate 14 is elliptically polarized light, the first retardation plate 14 only needs to have a retardation for converting incident light into circularly polarized light.

In addition, in the examples shown in FIGS. 2 and 4, from the viewpoint of converting incident circularly polarized light into linearly polarized light, it is preferable that the second retardation plate 22 is a λ/4 plate. Therefore, the second retardation plate 22 only needs to be a λ/4 plate with respect to wavelengths of visible range.

In addition, from the viewpoints of a reduction in thickness, viewing angle, and the like of the image display unit, the focal length f of the polarization diffraction element (polarization diffraction lens) is preferably less than 40 mm, more preferably 1 mm or more and 30 mm or less, and still more preferably 3 mm or more and 15 mm or less.

In addition, for example, from the viewpoint of displaying a virtual image, the distance d between the image display system and the polarization diffraction element only needs to be less than or equal to the focal length f of the polarization diffraction element. From the viewpoint of displaying a distant virtual image, the ratio d/f of the distance d to the focal length f is preferably in a range of 0.8 to 1, more preferably in a range of 0.9 to 1, and still more preferably in a range of 0.95 to 1.

Hereinafter, the members in the image display system will be described.

<Image Display Apparatus>

The image display apparatus emits an image (a static image or a moving image) that is displayed by the image display system.

The image display apparatus is not particularly limited. For example, various well-known displays used in a head-mounted display or the like can be used.

Examples of the display include a liquid crystal display (including Liquid Crystal On Silicon (LCOS)), an organic electroluminescent display, and a scanning type display employing a digital light processing (DLP) or Micro Electro Mechanical Systems (MEMS) mirror.

The image display apparatus may be a display that displays a monochromic image or may be a display that displays a polychromic image.

As described above, in the image display unit according to the embodiment of the present invention, light that is irradiated by the image display apparatus may be unpolarized light or linearly polarized light.

<Polarizing Plate>

The first and second linearly polarizing plates are not particularly limited as long as they are linearly polarizing plates having a function of allowing transmission of linearly polarized light in one polarization direction and absorbing linearly polarized light in another polarization direction. For example, a well-known linearly polarizing plate in the related art can be used. The linearly polarizing plate may be an absorptive linearly polarizing plate or a reflective linearly polarizing plate.

As the absorptive linearly polarizing plate, for example, an iodine-based polarizer, a dye-based polarizer using a dichroic dye, or a polyene polarizer that is an absorptive polarizer can be used. As the iodine-based polarizer and the dye-based polarizer, any one of a coating type polarizer or a stretching type polarizer can be used. In particular, a polarizer prepared by absorbing iodine or a dichroic dye on polyvinyl alcohol and performing stretching is preferable.

In addition, examples of a method of obtaining a polarizer by performing stretching and dyeing on a laminated film in which a polyvinyl alcohol layer is formed on the substrate include methods described in JP5143918B, JP5048120B, JP4691205B, JP4751481B, and JP4751486B, and well-known techniques relating to the polarizers can be used.

As the absorptive polarizer, for example, a polarizer obtained by aligning a dichroic coloring agent using the aligning properties of liquid crystal without performing stretching is more preferable. The polarizer has many advantages in that, for example, the thickness can be significantly reduced to about 0.1 μm to 5 μm, cracks are not likely to initiate or thermal deformation is small during folding as described in JP2019-194685A, and even a polarizing plate having a high transmittance of higher than 50% has excellent durability as described in JP6483486B, and thermoformability is excellent.

By utilizing these advantages, the polarizer is applicable to an application that requires high brightness or small size and light weight, an application of a fine optical system, or an application of forming into a portion having a curved surface, or an application of a flexible portion. In addition, a polarizer that is transferred after peeling a support can also be used.

In an on-board display optical system such as a head-up display, an optical system such as AR glasses or VR glasses, an optical sensor such as LiDAR, a face recognition system, or polarization imaging, or the like, it is also preferable that an absorptive polarizer is incorporated in order to prevent stray light.

As the reflective linearly polarizing plate, for example, a film obtained by stretching a layer including two polymers or a wire grid polarizer described in JP2011-053705A can be used. From the viewpoint of brightness, the film obtained by stretching the layer including polymers is preferable. As the commercially available product, for example, a reflective polarizer (trade name: APF) manufactured by 3M or a wire grid polarizer (trade name: WGF) manufactured by Asahi Kasei Corporation can be suitably used. Alternatively, a reflective linearly polarizing plate including a combination of a cholesteric liquid crystal film and a λ/4 plate may be used.

It is preferable that the polarizing plate used in the present invention has a smooth surface. In particular, in a case where the polarizing plate is applied to a lens or the like, due to the image enlargement effect of the lens, small surface unevenness may lead to distortion of the image. Therefore, it is desirable that the surface does not have unevenness. Specifically, an arithmetic average roughness Ra of the surface is preferably 50 nm or less, more preferably 30 nm or less, still more preferably 10 nm or less, and most preferably 5 nm or less. In addition, on the surface of the polarizing plate, a difference in height of the surface unevenness in a range of 1 square millimeter is preferably 100 nm or less, more preferably 50 nm or less, and most preferably 20 nm or less.

The surface unevenness and the arithmetic average roughness can be measured using a roughness meter or an interferometer. For example, the surface unevenness and the arithmetic average roughness can be measured using an interferometer “Vertscan” (manufactured by Mitsubishi Chemical Systems Inc.).

(Retardation Plate)

The first and second retardation plates are retardation plates that convert the phase of incident polarized light. The retardation plate is disposed such that a direction of a slow axis is adjusted depending on whether to convert incident polarized light into light similar to linearly polarized light or circularly polarized light. Specifically, the retardation plate may be disposed such that an angle of a slow axis with respect to a transmission axis of a linearly polarizing plate disposed adjacent thereto is +45° or −45°.

The retardation plate used in the present invention may be a monolayer type including one optically-anisotropic layer or a multilayer type including two or more optically-anisotropic layers having different slow axes. Examples of the multilayer type retardation plate include those described in WO13/137464A, WO2016/158300A, JP2014-209219A, JP2014-209220A, WO14/157079A, JP2019-215416A, and WO2019/160044A. However, the present invention is not limited to this example.

From the viewpoint of converting linearly polarized light into circularly polarized light or converting circularly polarized light into linearly polarized light, it is preferable that the retardation plate is a λ/4 plate.

The λ/4 plate is not particularly limited, and various well-known plates having a λ/4 function can be used. Specific examples of the λ/4 plate include those described in US2015/0277006A.

Specific examples of an aspect where the λ/4 plate has a monolayer structure include a stretched polymer film and a retardation film where an optically-anisotropic layer having a λ/4 function is provided on a support. Examples of an aspect in which the λ/4 plate has a multi-layer structure include a broadband λ/4 plate in which a λ/4 plate and a λ/2 wave plate are laminated.

The thickness of the λ/4 plate is not particularly limited and is preferably 1 to 500 μm, more preferably 1 to 50 μm, and still more preferably 1 to 5 μm.

It is preferable that the retardation plate used in the present invention has reverse wavelength dispersibility. By having reverse wavelength dispersibility, a phase change in the retardation plate is ideal, and conversion between linearly polarized light and circularly polarized light is ideal.

<Polarization Diffraction Element>

The polarization diffraction element is a polarization diffraction lens having a lens function of diffracting polarized light to focus the diffracted polarized light. As described above, the polarization diffraction element may diffract linearly polarized light or may diffract circularly polarized light.

Examples of the polarization diffraction element that diffracts linearly polarized light include a volume hologram type diffraction element. In addition, in order to achieve a configuration of focusing the polarized light diffracted by the diffraction structure, for example, the polarization diffraction element is configured such that the diffraction angle increases in a direction from the center of the light diffraction element toward the outer side thereof

(Liquid Crystal Diffraction Element)

Examples of the polarization diffraction element that diffracts circularly polarized light include a liquid crystal diffraction element.

For example, FIG. 5 is a conceptual diagram showing the positive lens including the liquid crystal diffraction element. FIG. 5 is a plan view conceptually showing a liquid crystal layer including the liquid crystal diffraction element.

The liquid crystal diffraction element includes a liquid crystal layer that is formed of a composition including a liquid crystal compound and has a predetermined liquid crystal alignment pattern in which an optical axis derived from the liquid crystal compound rotates. In the example shown in FIG. 5, a liquid crystal alignment pattern in a liquid crystal layer 36 is a concentric circular pattern having a concentric circular shape where the one in-plane direction in which a direction of an optical axis of a liquid crystal compound 40 changes while continuously rotating moves from an inner side toward an outer side. The concentric circular pattern is a pattern in which a line that connects liquid crystal compounds of which optical axes face the same direction has a circular shape and circular line segments have a concentric circular shape. In other words, the liquid crystal alignment pattern of the liquid crystal layer 36 shown in FIG. 5 is a liquid crystal alignment pattern where the one in-plane direction in which the direction of the optical axis of the liquid crystal compound 40 changes while continuously rotating is provided in a radial shape from the center of the liquid crystal layer 36.

In the liquid crystal layer 36 shown in FIG. 5, the optical axis (not shown) of the liquid crystal compound 40 is a longitudinal direction of the liquid crystal compound 40.

In the liquid crystal layer 36, the direction of the optical axis of the liquid crystal compound 40 changes while continuously rotating in a large number of directions moving to the outer side from the center of the liquid crystal layer 36, for example, a direction indicated by an arrow A₁, a direction indicated by an arrow A₂, a direction indicated by an arrow A₃, or . . . . The arrow A₁, the arrow A₂, and the arrow A₃ are arrangement axes described below.

In addition, the liquid crystal layer 36 in the liquid crystal diffraction element has regions where single periods Λ of the liquid crystal alignment pattern described below are different in a plane. Here, the single period Λ of the liquid crystal alignment pattern refers to a length (distance) over which the optical axis of the liquid crystal compound 40 in the liquid crystal alignment pattern rotates by 180° in the one in-plane direction in which the direction of the optical axis changes while continuously rotating.

Specifically, in the example shown in FIG. 5, in each of the directions in which the direction of the optical axis derived from the liquid crystal compound 40 changes while continuously rotating, the single period Λ gradually decreases from the center toward the outer side.

Although described below in detail, the diffraction angle of the liquid crystal diffraction element depends on the single period Λ of the liquid crystal alignment pattern, and as the single period Λ decreases, the diffraction angle increases.

In a case where the liquid crystal layer 36 has the configuration in which the one in-plane direction in which the direction of the optical axis of the liquid crystal compound 40 in the liquid crystal alignment pattern changes while continuously rotating is provided in a radial shape from the center of the liquid crystal layer 36 and in which the single period Λ of the liquid crystal alignment pattern gradually decreases from the center toward the outer side in each of the one in-plane directions, in circularly polarized light incident into the liquid crystal layer 36 having the above-described liquid crystal alignment pattern, the absolute phase changes depending on individual local regions having different directions of optical axes of the liquid crystal compound 40. In this case, the amount of change in absolute phase varies depending on the directions of the optical axes of the liquid crystal compound 40 into which circularly polarized light is incident. In addition, the diffraction angles vary depending on the single periods in the regions where circularly polarized light is incident. In the liquid crystal layer 36 having the concentric circular liquid crystal alignment pattern, that is, the liquid crystal alignment pattern in which the optical axis changes while continuously rotating in a radial shape, transmission of incidence light can be allowed as converging light depending on the rotation direction of the optical axis of the liquid crystal compound 40 and the direction of circularly polarized light to be incident.

That is, by setting the liquid crystal alignment pattern of the liquid crystal layer in a concentric circular shape, the liquid crystal diffraction element exhibits, for example, a function as a convex lens.

Hereinafter, the liquid crystal layer of the liquid crystal diffraction element will be described in more detail.

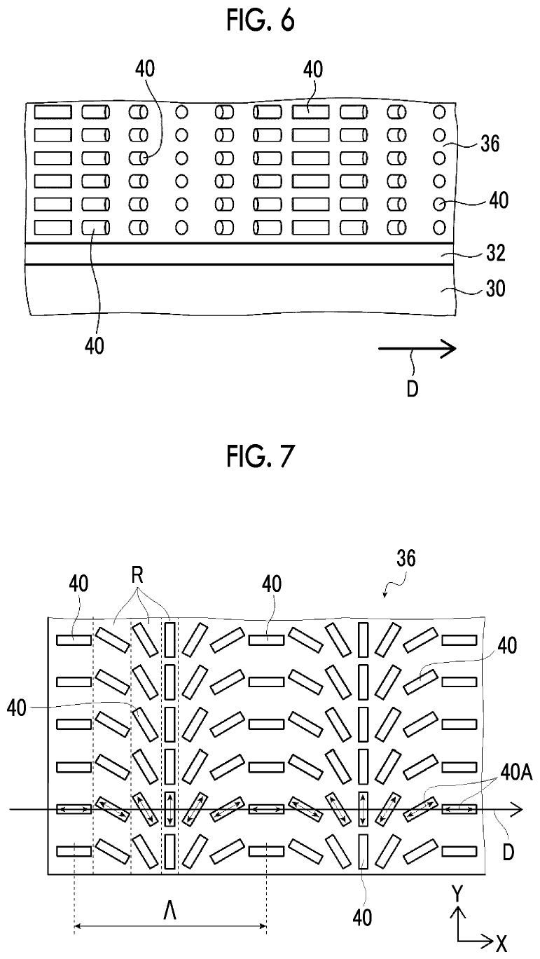

FIG. 6 is a conceptual diagram in a case where a cross section of the liquid crystal layer 36 taken in the one in-plane direction in which the direction of the optical axis 40A of the liquid crystal compound 40 changes while continuously rotating is locally seen. FIG. 7 is a plan view of FIG. 6.

The liquid crystal diffraction element in the example shown in FIG. 6 includes a support 30, an alignment film 32, and a liquid crystal layer (hereinafter, also referred to as “optically-anisotropic layer”) 36.

As described above, the liquid crystal diffraction element includes a liquid crystal layer that is formed of a composition including a liquid crystal compound and has a predetermined liquid crystal alignment pattern in which an optical axis derived from the liquid crystal compound rotates. In addition, as described below, the liquid crystal layer has regions where the single periods Λ of the liquid crystal alignment pattern are different in a plane.

In addition, the liquid crystal diffraction element in the example shown in FIG. 6 includes the support 30. However, the support 30 does not need to be provided.

For example, the optical element according to the embodiment of the present invention may include only the alignment film and the liquid crystal layer by peeling off the support 30 from the above-described configuration or may include only the liquid crystal layer by peeling off the support 30 and the alignment film from the above-described configuration.

That is, in the liquid crystal diffraction element, the liquid crystal layer can adopt various layer configurations as long as it has the liquid crystal alignment pattern in which the direction of the optical axis derived from the liquid crystal compound rotates in one direction.

<<Support>>

In the liquid crystal diffraction element, the support 30 supports the alignment film 32 and the liquid crystal layer 36.

As the support 30, various sheet-shaped materials (films or plate-shaped materials) can be used as long as they can support the alignment film and the liquid crystal layer.

As the support 30, a transparent support is preferable, and examples thereof include a polyacrylic resin film such as polymethyl methacrylate, a cellulose resin film such as cellulose triacetate, a cycloolefin polymer film (for example, trade name “ARTON”, manufactured by JSR Corporation; or trade name “ZEONOR”, manufactured by Zeon Corporation), polyethylene terephthalate (PET), polycarbonate, and polyvinyl chloride. The support is not limited to a flexible film and may be a non-flexible substrate such as a glass substrate.

In addition, the support 30 may have a multi-layer structure. Examples of the multi-layer support include a support including: one of the above-described supports having a single-layer structure that is provided as a substrate; and another layer that is provided on a surface of the substrate.

The thickness of the support 30 is not particularly limited and may be appropriately set depending on the use of the liquid crystal diffraction element, a material for forming the support 30, and the like in a range where the alignment film and the liquid crystal layer can be supported.

The thickness of the support 30 is preferably 1 to 1000 μm, more preferably 3 to 500 μm, and still more preferably 5 to 250 μm.

<<Alignment Film>>

In the liquid crystal diffraction element, the alignment film 32 is formed on a surface of the support 30.

The alignment film 32 is an alignment film for aligning a liquid crystal compound 40 to a predetermined liquid crystal alignment pattern during the formation of the liquid crystal layer 36 of the liquid crystal diffraction element.

Although described below, in the liquid crystal diffraction element, the liquid crystal layer has a liquid crystal alignment pattern in which a direction of an optical axis 40A (refer to FIG. 7) derived from the liquid crystal compound 40 changes while continuously rotating in one in-plane direction (arrangement axis D direction described below). Accordingly, the alignment film of the liquid crystal diffraction element is formed such that the liquid crystal layer can form this liquid crystal alignment pattern.

In addition, in the liquid crystal alignment pattern, a length over which the direction of the optical axis 40A rotates by 180° in the one in-plane direction in which the direction of the optical axis 40A changes while continuously rotating is set as a single period Λ (a rotation period of the optical axis).

In the following description, “the direction of the optical axis 40A rotates” will also be simply referred to as “the optical axis 40A rotates”.

As the alignment film, various well-known films can be used.

Examples of the alignment film include a rubbed film consisting of an organic compound such as a polymer, an obliquely deposited film formed of an inorganic compound, a film having a microgroove, and a film formed by lamination of Langmuir-Blodgett (LB) films formed with a Langmuir-Blodgett's method using an organic compound such as ω-tricosanoic acid, dioctadecylmethylammonium chloride, or methyl stearate.

The alignment film formed by a rubbing treatment can be formed by rubbing a surface of a polymer layer with paper or fabric in a given direction multiple times. As the material used for the alignment film, for example, a material for forming polyimide, polyvinyl alcohol, a polymer having a polymerizable group described in JP1997-152509A (JP-H9-152509A), or an alignment film such as JP2005-97377A, JP2005-99228A, and JP2005-128503A is preferable.

In the liquid crystal diffraction element, the alignment film can be suitably used as a so-called photo-alignment film obtained by irradiating a photo-alignment material with polarized light or non-polarized light. That is, in the liquid crystal diffraction element, a photo-alignment film that is formed by applying a photo-alignment material to the support 30 is suitably used as the alignment film.

The irradiation of polarized light can be performed in a direction perpendicular or oblique to the photo-alignment film, and the irradiation of non-polarized light can be performed in a direction oblique to the photo-alignment film.

Preferable examples of the photo-alignment material used in the photo-alignment film that can be used in the present invention include: an azo compound described in JP2006-285197A, JP2007-76839A, JP2007-138138A, JP2007-94071A, JP2007-121721A, JP2007-140465A, JP2007-156439A, JP2007-133184A, JP2009-109831A, JP3883848B, and JP4151746B; an aromatic ester compound described in JP2002-229039A; a maleimide- and/or alkenyl-substituted nadiimide compound having a photo-alignable unit described in JP2002-265541A and JP2002-317013A; a photocrosslinking silane derivative described in JP4205195B and JP4205198B, a photocrosslinking polyimide, a photocrosslinking polyamide, or a photocrosslinking ester described in JP2003-520878A, JP2004-529220A, and JP4162850B; and a photodimerizable compound, in particular, a cinnamate (cinnamic acid) compound, a chalcone compound, or a coumarin compound described in JP1997-118717A (JP-H9-118717A), JP1998-506420A (JP-H10-506420A), JP2003-505561A, WO2010/150748A, JP2013-177561A, and JP2014-12823A.

Among these, an azo compound, a photocrosslinking polyimide, a photocrosslinking polyamide, a photocrosslinking ester, a cinnamate compound, or a chalcone compound is suitably used.

The thickness of the alignment film is not particularly limited. The thickness with which a required alignment function can be obtained may be appropriately set depending on the material for forming the alignment film.

The thickness of the alignment film is preferably 0.01 to 5 μm and more preferably 0.05 to 2 μm.

A method of forming the alignment film is not limited. Any one of various well-known methods corresponding to a material for forming the alignment film can be used. For example, a method including: applying the alignment film to a surface of the support 30; drying the applied alignment film; and exposing the alignment film to laser light to form an alignment pattern can be used.

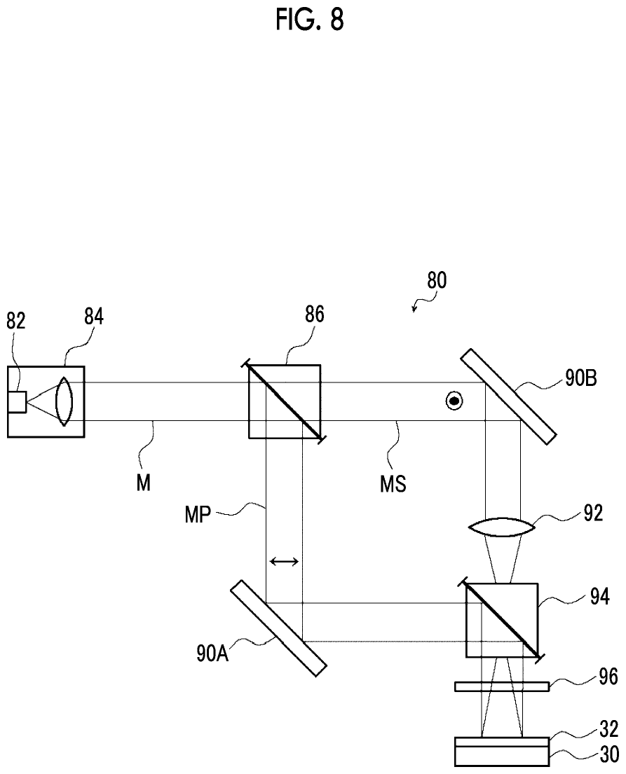

FIG. 8 conceptually shows an example of an exposure device that forms the concentric circular alignment pattern in the alignment film.

An exposure device 80 includes: a light source 84 that includes a laser 82; a polarization beam splitter 86 that divides the laser light M emitted from the laser 82 into S polarized light MS and P polarized light MP; a mirror 90A that is disposed on an optical path of the P polarized light MP; a mirror 90B that is disposed on an optical path of the S polarized light MS; a lens 92 that is disposed on the optical path of the S polarized light MS; a polarization beam splitter 94; and a λ/4 plate 96.

The P polarized light MP that is split by the polarization beam splitter 86 is reflected from the mirror 90A to be incident into the polarization beam splitter 94. On the other hand, the S polarized light MS that is split by the polarization beam splitter 86 is reflected from the mirror 90B and is collected by the lens 92 to be incident into the polarization beam splitter 94.

The P polarized light MP and the S polarized light MS are multiplexed by the polarization beam splitter 94, are converted into right circularly polarized light and left circularly polarized light by the λ/4 plate 96 depending on the polarization direction, and are incident into the alignment film 32 on the support 30.

Here, due to interference between the right circularly polarized light and the left circularly polarized light, the polarization state of light with which the alignment film is irradiated periodically changes according to interference fringes. The intersecting angle between the right circularly polarized light and the left circularly polarized light changes from the inside to the outside of the concentric circle. Therefore, an exposure pattern in which the pitch changes from the inner side to the outer side can be obtained. As a result, in the alignment film, a concentric circular alignment pattern in which the alignment state periodically changes can be obtained.

In the exposure device 80, the single period Λ in the liquid crystal alignment pattern in which the optical axis of the liquid crystal compound 40 continuously rotates by 180° in the one in-plane direction can be controlled by changing the refractive power of the lens 92 (the F number of the lens 92), the focal length of the lens 92, the distance between the lens 92 and the alignment film 32, and the like.

In addition, by adjusting the refractive power of the lens 92 (the F number of the lens 92), the length A of the single period in the liquid crystal alignment pattern in the one in-plane direction in which the optical axis continuously rotates can be changed.

Specifically, In addition, the length A of the single period in the liquid crystal alignment pattern in the one in-plane direction in which the optical axis continuously rotates can be changed depending on a light spread angle at which light is spread by the lens 92 due to interference with parallel light. More specifically, in a case where the refractive power of the lens 92 is weak, light is approximated to parallel light. Therefore, the length A of the single period in the liquid crystal alignment pattern gradually decreases from the inner side toward the outer side, and the F number increases. Conversely, in a case where the refractive power of the lens 92 becomes stronger, the length A of the single period in the liquid crystal alignment pattern rapidly decreases from the inner side toward the outer side, and the F number decreases.

As described above, the alignment film (hereinafter, also referred to as the patterned alignment film) on which the pattern is formed by the exposure has a liquid crystal alignment pattern in which the liquid crystal compound is aligned such that the direction of the optical axis of the liquid crystal compound in the liquid crystal layer formed on the patterned alignment film changes while continuously rotating in at least one in-plane direction. In a case where an axis in the direction in which the liquid crystal compound is aligned is an alignment axis, it can be said that the patterned alignment film has an alignment pattern in which the direction of the alignment axis changes while continuously rotating in at least one in-plane direction. The alignment axis of the patterned alignment film can be detected by measuring absorption anisotropy. For example, in a case where the amount of light transmitted through the patterned alignment film is measured by irradiating the patterned alignment film with linearly polarized light while rotating the patterned alignment film, it is observed that a direction in which the light amount is the maximum or the minimum gradually changes in the one in-plane direction.

In the liquid crystal diffraction element, the alignment film is provided as a preferable aspect and is not an essential configuration requirement.

For example, the following configuration can also be adopted, in which, by forming the alignment pattern on the support 30 using a method of rubbing the support 30, a method of processing the support 30 with laser light or the like, the liquid crystal layer 36 or the like has the liquid crystal alignment pattern in which the direction of the optical axis 40A derived from the liquid crystal compound 40 changes while continuously rotating in at least one in-plane direction.

<<Liquid Crystal Layer>>

In the liquid crystal diffraction element, the liquid crystal layer 36 is formed on a surface of the alignment film 32.

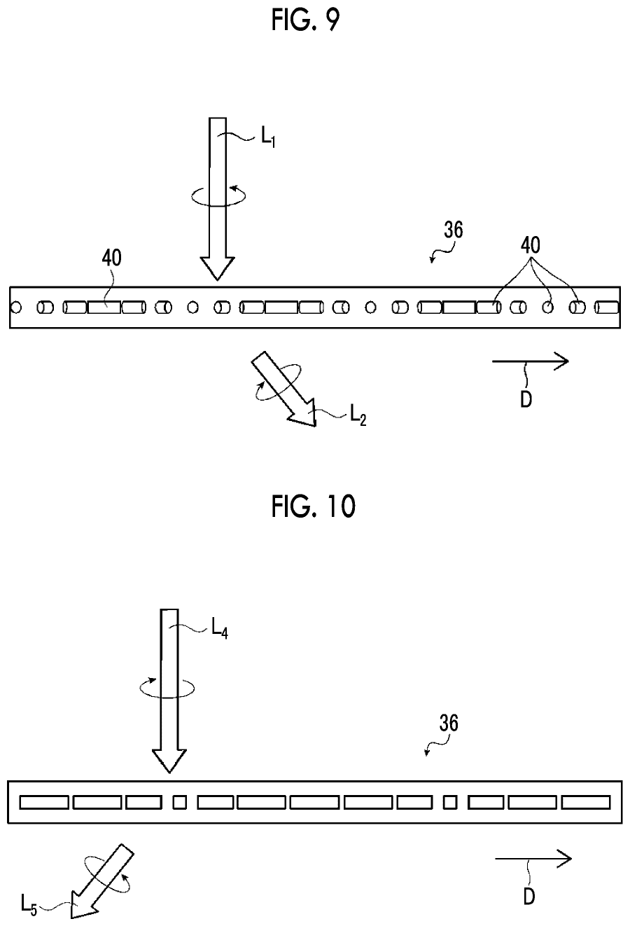

In FIG. 9 and FIG. 10 described below, in order to simplify the drawing and to clarify the configuration of the liquid crystal diffraction element, only the liquid crystal compound 40 (liquid crystal compound molecules) on the surface of the alignment film in the liquid crystal layer 36 is shown. However, as conceptually shown in FIG. 6, the liquid crystal layer 36 has a structure in which the aligned liquid crystal compounds 40 are laminated in the thickness direction as in a liquid crystal layer that is formed of a composition including a typical liquid crystal compound.

As described above, in the liquid crystal diffraction element, the liquid crystal layer 36 is formed of the liquid crystal composition including the liquid crystal compound.

In a case where an in-plane retardation value is set as λ/2, the liquid crystal layer has a function of a general λ/2 plate, that is, a function of imparting a phase difference of a half wavelength, that is, 180° to two linearly polarized light components in light incident into the liquid crystal layer and are perpendicular to each other.

Here, since the liquid crystal compound rotates to be aligned in a plane direction, the liquid crystal layer diffracts (refracts) incident circularly polarized light to be transmitted in a direction in which the direction of the optical axis continuously rotates. In this case, the diffraction direction varies depending on the turning direction of incident circularly polarized light.

That is, the liquid crystal layer allows transmission of circularly polarized light and diffracts this transmitted light.

In addition, the liquid crystal layer changes a turning direction of the transmitted circularly polarized light into an opposite direction.

The liquid crystal layer has the liquid crystal alignment pattern in which the direction of the optical axis derived from the liquid crystal compound changes while continuously rotating in the one in-plane direction indicated by arrangement axis D in a plane of the liquid crystal layer.

The optical axis 40A derived from the liquid crystal compound 40 is an axis having the highest refractive index in the liquid crystal compound 40, that is, a so-called slow axis. For example, in a case where the liquid crystal compound 40 is a rod-like liquid crystal compound, the optical axis 40A is parallel to a rod-like major axis direction.

In the following description, “one in-plane direction indicated by the arrangement axis D” will also be simply referred to as “arrangement axis D direction”. In addition, in the following description, the optical axis 40A derived from the liquid crystal compound 40 will also be referred to as “the optical axis 40A of the liquid crystal compound 40” or “the optical axis 40A”.

In the liquid crystal layer, the liquid crystal compound 40 is two-dimensionally aligned in a plane parallel to the arrangement axis D direction and a Y direction perpendicular to the arrangement axis D direction. In FIGS. 6 and FIGS. 9 to 13 described below, the Y direction is a direction perpendicular to the paper plane.

FIG. 7 conceptually shows a plan view of the liquid crystal layer 36.

The plan view is a view in a case where the liquid crystal diffraction element is seen from the top in FIG. 6, that is, a view in a case where the liquid crystal diffraction element is seen from a thickness direction (laminating direction of the respective layers (films)). In other words, the plan view is a view in a case where the liquid crystal layer 36 is seen from a direction perpendicular to a main surface.

In addition, in FIG. 7, in order to clarify the configuration of the liquid crystal diffraction element, only the liquid crystal compound 40 on the surface of the alignment film 32 is shown. However, in the thickness direction, as shown in FIG. 6, the liquid crystal layer 36 has the structure in which the liquid crystal compound 40 is laminated on the surface of the alignment film 32 as described above.

In FIGS. 6 and 7, a part in a plane of the liquid crystal layer 36 will be described as a representative example. However, basically, the liquid crystal layer described below also has the same configuration and the same effects as those of the liquid crystal layer 36, except that the lengths (single periods A) of the single periods of the liquid crystal alignment patterns in the regions of the liquid crystal layer are different from each other.

The liquid crystal layer 36 has the liquid crystal alignment pattern in which the direction of the optical axis 40A derived from the liquid crystal compound 40 changes while continuously rotating in the arrangement axis D direction in a plane of the liquid crystal layer 36.

Specifically, “the direction of the optical axis 40A of the liquid crystal compound 40 changes while continuously rotating in the arrangement axis D direction (the predetermined one in-plane direction)” represents that an angle between the optical axis 40A of the liquid crystal compound 40, which is arranged in the arrangement axis D direction, and the arrangement axis D direction varies depending on positions in the arrangement axis D direction, and the angle between the optical axis 40A and the arrangement axis D direction sequentially changes from θ to θ+180° or θ−180° in the arrangement axis D direction.

A difference between the angles of the optical axes 40A of the liquid crystal compounds 40 adjacent to each other in the arrangement axis D direction is preferably 45° or less, more preferably 15° or less, and still more preferably less than 15°.

On the other hand, regarding the liquid crystal compound 40 forming the liquid crystal layer 36, the liquid crystal compounds 40 having the same direction of the optical axes 40A are arranged at regular intervals in the Y direction perpendicular to the arrangement axis D direction, that is, the Y direction perpendicular to the one in-plane direction in which the optical axis 40A continuously rotates.

In other words, regarding the liquid crystal compound 40 forming the liquid crystal layer 36, in the liquid crystal compounds 40 arranged in the Y direction, angles between the directions of the optical axes 40A and the arrangement axis D direction are the same.

In the liquid crystal diffraction element, in the liquid crystal alignment pattern of the liquid crystal compound 40, the length (distance) over which the direction of the optical axis 40A of the liquid crystal compound 40 rotates by 180° in the arrangement axis D direction in which the optical axis 40A changes while continuously rotating in a plane is the length A of the single period in the liquid crystal alignment pattern. In other words, the length of the single period in the liquid crystal alignment pattern is defined as the distance between θ and θ+180° that is a range of the angle between the optical axis 40A of the liquid crystal compound 40 and the arrangement axis D direction.

That is, a distance between centers of two liquid crystal compounds 40 in the arrangement axis D direction is the length Λ of the single period, the two liquid crystal compounds having the same angle in the arrangement axis D direction. Specifically, as shown in FIG. 7, a distance between centers in the arrangement axis D direction of two liquid crystal compounds 40 in which the arrangement axis D direction and the direction of the optical axis 40A match each other is the length Λ of the single period. In the following description, the length Λ of the single period will also be referred to as “single period Λ”.

In the liquid crystal diffraction element, in the liquid crystal alignment pattern of the liquid crystal layer, the single period Λ is repeated in the arrangement axis D direction, that is, in the one in-plane direction in which the direction of the optical axis 40A changes while continuously rotating.

As described above, in the liquid crystal compounds arranged in the Y direction in the liquid crystal layer, the angles between the optical axes 40A and the arrangement axis D direction (the one in-plane direction in which the direction of the optical axis of the liquid crystal compound 40 rotates) are the same. Regions where the liquid crystal compounds 40 in which the angles between the optical axes 40A and the arrangement axis D direction are the same are disposed in the Y direction will be referred to as “regions R”.

In this case, it is preferable that an in-plane retardation (Re) value of each of the regions R is a half wavelength, that is, λ/2. The in-plane retardation is calculated from the product of a difference Δn in refractive index generated by refractive index anisotropy of the region R and the thickness of the liquid crystal layer. Here, the difference in refractive index generated by refractive index anisotropy of the region R in the liquid crystal layer is defined by a difference between a refractive index of a direction of an in-plane slow axis of the region R and a refractive index of a direction perpendicular to the direction of the slow axis. That is, the difference Δn in refractive index generated by refractive index anisotropy of the region R is the same as a difference between a refractive index of the liquid crystal compound 40 in the direction of the optical axis 40A and a refractive index of the liquid crystal compound 40 in a direction perpendicular to the optical axis 40A in a plane of the region R. That is, the difference Δn in refractive index is the same as the difference in refractive index of the liquid crystal compound.

In a case where circularly polarized light is incident into the above-described liquid crystal layer 36, the light is refracted such that the direction of the circularly polarized light is converted.

This action is conceptually shown in FIGS. 9 and 10. In the liquid crystal layer 36, the value of the product of the difference in refractive index of the liquid crystal compound and the thickness of the liquid crystal layer 36 is λ/2.

As shown in FIG. 9, in a case where the value of the product of the difference in refractive index of the liquid crystal compound in the liquid crystal layer 36 and the thickness of the liquid crystal layer 36 is λ/2 and incidence light L₁ as left circularly polarized light is incident into the liquid crystal layer 36, the incidence light L₁ transmits through the liquid crystal layer 36 to be imparted with a retardation of 180°, and the transmitted light L₂ is converted into right circularly polarized light.

In addition, the liquid crystal alignment pattern formed in the liquid crystal layer 36 is a pattern that is periodic in the arrangement axis D direction. Therefore, the transmitted light L₂ travels in a direction different from a traveling direction of the incidence light L₁. This way, the incidence light L₁ of the left circularly polarized light is converted into the transmitted light L₂ of right circularly polarized light that is tilted by a predetermined angle in the arrangement axis D direction with respect to an incidence direction.

On the other hand, as shown in FIG. 10, in a case where the value of the product of the difference in refractive index of the liquid crystal compound in the liquid crystal layer 36 and the thickness of the liquid crystal layer 36 is λ/2 and incidence light L₄ of right circularly polarized light is incident into the liquid crystal layer 36, the incidence light L₄ transmits through the liquid crystal layer 36 to be imparted with a retardation of 180°, and the transmitted light L₄ is converted into transmitted light L₅ of left circularly polarized light.

In addition, the liquid crystal alignment pattern formed in the liquid crystal layer 36 is a pattern that is periodic in the arrangement axis D direction. Therefore, the transmitted light L₅ travels in a direction different from a traveling direction of the incidence light L₄. In this case, the transmitted Light L₅ travels in a direction different from the transmitted light L₂, that is, in a direction opposite to the arrangement axis D direction with respect to the incidence direction. This way, the incidence light L₄ is converted into the transmitted light L₅ of left circularly polarized light that is tilted by a predetermined angle in a direction opposite to the arrangement axis D direction with respect to an incidence direction.

By changing the single period Λ of the liquid crystal alignment pattern formed in the liquid crystal layer 36, refraction angles of the transmitted light components L₂ and L₅ can be adjusted. Specifically, even in the liquid crystal layer 36, as the single period Λ of the liquid crystal alignment pattern decreases, light components transmitted through the liquid crystal compounds 40 adjacent to each other more strongly interfere with each other. Therefore, the transmitted light components L₂ and L₅ can be more largely refracted.

In addition, by reversing the rotation direction of the optical axis 40A of the liquid crystal compound 40 that rotates in the arrangement axis D direction, the refraction direction of transmitted light can be reversed. That is, in the example FIGS. 9 and 10, the rotation direction of the optical axis 40A toward the arrangement axis D direction is clockwise. By setting this rotation direction to be counterclockwise, the refraction direction of transmitted light can be reversed.

In the liquid crystal layer 36, it is preferable that the in-plane retardation value of the plurality of regions R is a half wavelength. It is preferable that an in-plane retardation Re(550)=Δn₅₅₀×d of the plurality of regions R of the liquid crystal layer 36 with respect to the incidence light having a wavelength of 550 nm is in a range defined by the following Expression (1). Here, Δn₅₅₀ represents a difference in refractive index generated by refractive index anisotropy of the region R in a case where the wavelength of incidence light is 550 nm, and d represents the thickness of the liquid crystal layer 36.

200 nm≤Δn₅₅₀×d≤350 nm (1).

That is, in a case where the in-plane retardation Re(550)=Δn₅₅₀×d of the plurality of regions R of the liquid crystal layer 36 satisfies Expression (1), a sufficient amount of a circularly polarized light component in light incident into the liquid crystal layer 36 can be converted into circularly polarized light that travels in a direction tilted in a forward direction or reverse direction with respect to the arrangement axis D direction. It is more preferable that the in-plane retardation Re(550)=Δn₅₅₀×d satisfies 225 nm≤Δn₅₅₀×d≤340 nm, and it is still more preferable that the in-plane retardation Re(550)=Δn₅₅₀×d satisfies 250 nm≤Δn₅₅₀×d≤330 nm.

Expression (1) is a range with respect to incidence light having a wavelength of 550 nm. However, an in-plane retardation Re(λ)=Δn_{λ}×d of the plurality of regions R of the liquid crystal layer with respect to incidence light having a wavelength of λ nm is preferably in a range defined by the following Expression (1-2) and can be appropriately set.

0.7×(λ/2)nm≤Δn_{λ}×d≤1.3×(λ/2)nm (1-2)

Further, it is preferable that an in-plane retardation Re(450)=Δn₄₅₀×d of each of the plurality of regions R of the liquid crystal layer 36 with respect to incidence light having a wavelength of 450 nm and an in-plane retardation Re(550)=Δn₅₅₀×d of each of the plurality of regions R of the liquid crystal layer 36 with respect to incidence light having a wavelength of 550 nm satisfy the following Expression (2). Here, Δn₄₅₀ represents a difference in refractive index generated by refractive index anisotropy of the region R in a case where the wavelength of incidence light is 450 nm.

(Δn₄₅₀×d)/(Δn₅₅₀×d)<1.0 (2)

Expression (2) represents that the liquid crystal compound 40 in the liquid crystal layer 36 has reverse dispersion properties. That is, by satisfying Expression (2), the liquid crystal layer 36 can correspond to incidence light having a wide range of wavelength.

The liquid crystal layer is formed of a cured layer of a liquid crystal composition including a rod-like liquid crystal compound or a disk-like liquid crystal compound, and has a liquid crystal alignment pattern in which an optical axis of the rod-like liquid crystal compound or an optical axis of the disk-like liquid crystal compound is aligned as described above.

By forming an alignment film on the support, applying the liquid crystal composition to the alignment film, and curing the applied liquid crystal composition, the liquid crystal layer consisting of the cured layer of the liquid crystal composition can be obtained. Although the liquid crystal layer functions as a so-called λ/2 plate, the present invention includes an aspect where a laminate including the support and the alignment film that are integrated functions as a λ/2 plate.

In addition, the liquid crystal composition for forming the liquid crystal layer includes a rod-like liquid crystal compound or a disk-like liquid crystal compound and may further include other components such as a leveling agent, an alignment control agent, a polymerization initiator, or an alignment assistant.

In addition, it is preferable that the liquid crystal layer has a wide range for the wavelength of incidence light and is formed of a liquid crystal material having a reverse birefringence index dispersion. In addition, it is also preferable that the liquid crystal layer can be made to have a substantially wide range for the wavelength of incidence light by imparting a twist component to the liquid crystal composition or by laminating different retardation layers. For example, in the liquid crystal layer, a method of realizing a λ/2 plate having a wide-range pattern by laminating two liquid crystal layers having different twisted directions is disclosed in, for example, JP2014-089476A and can be preferably used in the present invention.

—Rod-Like Liquid Crystal Compound—

As the rod-like liquid crystal compound, an azomethine compound, an azoxy compound, a cyanobiphenyl compound, a cyanophenyl ester compound, a benzoate compound, a phenyl cyclohexanecarboxylate compound, a cyanophenylcyclohexane compound, a cyano-substituted phenylpyrimidine compound, an alkoxy-substituted phenylpyrimidine compound, a phenyldioxane compound, a tolan compound, or an alkenylcyclohexylbenzonitrile compound is preferably used. As the rod-like liquid crystal compound, not only the above-described low molecular weight liquid crystal molecules but also high molecular weight liquid crystal molecules can be used.

It is preferable that the alignment of the rod-like liquid crystal compound is immobilized by polymerization. Examples of the polymerizable rod-like liquid crystal compound include compounds described in Makromol. Chem., (1989), Vol. 190, p. 2255, Advanced Materials (1993), Vol. 5, p. 107, U.S. Pat. Nos. 4,683,327A, 5,622,648A, 5,770,107A, WO95/22586A, WO95/24455A, WO97/00600A, WO98/23580A, WO98/52905A, JP1989-272551A (JP-H1-272551A), JP1994-16616A (JP-H6-16616A), JP1995-110469A (JP-H7-110469A), JP1999-80081A (JP-H11-80081A), and JP2001-64627. Further, as the rod-like liquid crystal compound, for example, compounds described in JP1999-513019A (JP-H11-513019A) and JP2007-279688A can also be preferably used.

—Disk-Like Liquid Crystal Compound—

As the disk-like liquid crystal compound, for example, compounds described in JP2007-108732A and JP2010-244038A can be preferably used.

In a case where the disk-like liquid crystal compound is used in the liquid crystal layer, the liquid crystal compound 40 rises in the thickness direction in the liquid crystal layer, and the optical axis 40A derived from the liquid crystal compound is defined as an axis perpendicular to a disc plane, that is, a so-called fast axis.

In order to obtain a high diffraction efficiency, it is preferable that a liquid crystal compound having high refractive index anisotropy Δn is used as the liquid crystal compound. By increasing the refractive index anisotropy, a high diffraction efficiency can be maintained in a case where the incidence angle changes. The liquid crystal compound having high refractive index anisotropy Δn is not particularly limited. For example, a compound described in WO2019/182129A1 or a compound represented by Formula (I) can be preferably used.

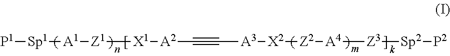

In Formula (I),

P¹ and P² each independently represent a hydrogen atom, —CN, —NCS, or a polymerizable group.

Sp¹ and Sp² each independently represent a single bond or a divalent linking group. Here, Sp¹ and Sp² do not represent a divalent linking group including at least one group selected from the group consisting of an aromatic hydrocarbon ring group, an aromatic heterocyclic group, and an aliphatic hydrocarbon ring group.

Z¹, Z², and Z³ each independently represents a single bond, —O—, —S—, —CHR—, —CHRCHR—, —OCHR—, —CHRO—, —SO—, —SO₂—, —COO—, —OCO—, —CO—S—, —S—CO—, —O—CO—O—, —CO—NR—, —NR—CO—, —SCHR—, —CHRS—, —SO—CHR—, —CHR—SO—, —SO₂—CHR—, —CHR—SO₂—, —CF₂O—, —OCF₂—, —CF₂S—, —SCF₂—, —OCHRCHRO—, —SCHRCHRS—, —SO—CHRCHR—SO—, —SO₂—CHRCHR—SO₂—, —CH═CH—COO—, —CH═CH—OCO—, —COO—CH═CH—, —OCO—CH═CH—, —COO—CHRCHR—, —OCO—CHRCHR—, —CHRCHR—COO—, —CHRCHR—OCO—, —COO—CHR—, —OCO—CHR—, —CHR—COO—, —CHR—OCO—, —CR═CR—, —CR═N—, —N═CR—, —N═N—, —CR═N—N═CR—, —CF═CF—, or —C≡C—. R represents a hydrogen atom or an alkyl group having 1 to 10 carbon atoms. In a case where a plurality of R's are present, R's may be the same as or different from each other. In a case where a plurality of Z¹'s and a plurality of Z²'s are present, Z¹'s and Z²'s may be the same as or different from each other. In a case where a plurality of Z³'s are present, Z³'s may be the same as or different from each other. Here, Z³ connected to SP² represents a single bond.

X¹ and X² each independently represents a single bond or —S—. In a case where a plurality of X¹'s and a plurality of X²'s are present, X¹'s and X²'s may be the same as or different from each other. Here, among the plurality of X¹'s and a plurality of X²'s, at least one represents —S—.

k represents an integer of 2 to 4.

m and n each independently represent an integer of 0 to 3. In a case where a plurality of m's are present, m's may be the same as or different from each other.

A¹, A², A³, and A⁴ each independently represent a group represented by any one of Formulas (B-1) to (B-7) or a group where two or three groups among the groups represented by Formulas (B-1) to (B-7) are linked. In a case where a plurality of A²'s and a plurality of A³'s are present, A²'s and A³'s may be the same as or different from each other. In a case where a plurality of A¹'s and a plurality of A⁴'s are present, A¹'s and A⁴'s may be the same as or different from each other.

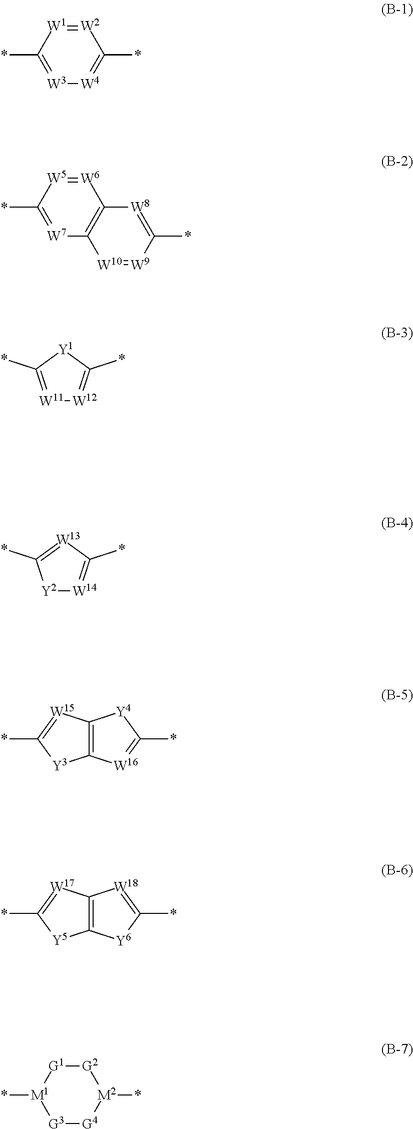

In Formulas (B-1) to (B-7),

W¹ to W¹⁸ each independently represent CR¹ or N, and R¹ represents a hydrogen atom or the following substituent L.

Y¹ to Y⁶ each independently represent NR², O, or S, and R2 represents a hydrogen atom or the following substituent L.

G¹ to G⁴ each independently represent CR³R⁴, NRS, O, or S, and R³ to R⁵ each independently represent a hydrogen atom or the following substituent L.

M¹ and M² each independently represent CR⁶ or N, and R⁶ represents a hydrogen atom or the following substituent L.

* represents a bonding position.

The substituent L represents an alkyl group having 1 to 10 carbon atoms, an alkoxy group having 1 to 10 carbon atoms, an alkylamino group having 1 to 10 carbon atoms, an alkylthio group having 1 to 10 carbon atoms, an alkanoyl group having 1 to 10 carbon atoms, an alkanoyloxy group having 1 to 10 carbon atoms, an alkanoylamino group having 1 to 10 carbon atoms, an alkanoylthio group having 1 to 10 carbon atoms, an alkyloxycarbonyl group having 2 to 10 carbon atoms, an alkylaminocarbonyl group having 2 to 10 carbon atoms, an alkylthiocarbonyl group having 2 to 10 carbon atoms, a hydroxy group, an amino group, a mercapto group, a carboxy group, a sulfo group, an amido group, a cyano group, a nitro group, a halogen atom, or a polymerizable group. Here, in a case where the group described as the substituent L has —CH₂—, a group in which at least one —CH₂— in the group is substituted with —O—, —CO—, —CH═CH—, or —C≡C— is also included in the substituent L. Here, in a case where the group described as the substituent L has a hydrogen atom, a group in which at least one hydrogen atom-in the group is substituted with at least one selected from the group consisting of a fluorine atom and a polymerizable group is also included in the substituent L.

In order to maintain a high diffraction efficiency in a case where the incidence angle changes, the refractive index anisotropy Δn₅₅₀ of the liquid crystal compound is preferably 0.15 or more, more preferably 0.2 or more, still more preferably 0.25 or more, and most preferably 0.3 or more.

<Action of Liquid Crystal Diffraction Element>

As described above, the liquid crystal layer that is formed using the composition including the liquid crystal compound and has the liquid crystal alignment pattern in which the direction of the optical axis 40A rotates in the arrangement axis D direction refracts circularly polarized light, in which as the single periods Λ of the liquid crystal alignment pattern decreases, the refraction angle is large.

Therefore, in a case where a pattern is formed such that the single periods Λ of the liquid crystal alignment patterns are different from each other in different in-plane regions, light that is incident into the different in-plane regions is refracted at different angles.

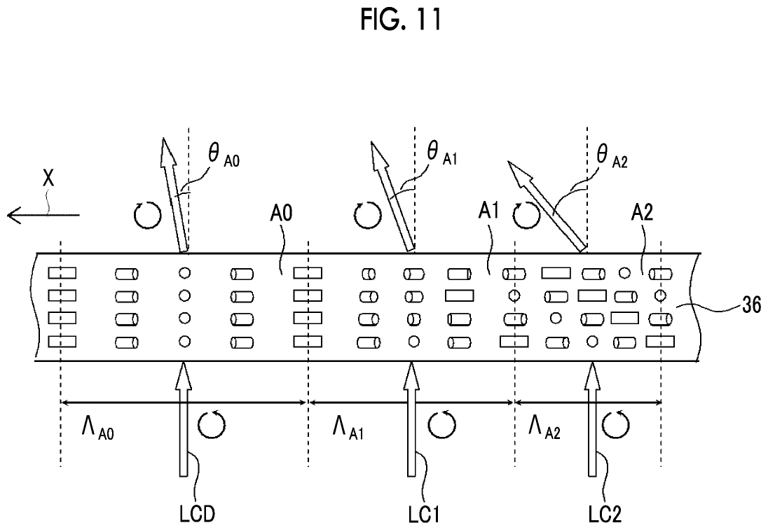

Hereinafter, the action of the liquid crystal diffraction element will be described in detail with reference to the conceptual diagrams of FIG. 11. FIG. 11 is a conceptual diagram in a case where a cross section of the liquid crystal layer 36 taken in the one in-plane direction in which the direction of the optical axis 40A of the liquid crystal compound 40 changes while continuously rotating is partially seen in the one in-plane direction.

In the liquid crystal diffraction element, basically, only the liquid crystal layer exhibits an optical action. Therefore, in order to simplify the drawing and to clarify the configuration and the effects, in FIG. 11, the liquid crystal diffraction element exhibits only the liquid crystal layer 36.

As described above, the liquid crystal diffraction element includes the liquid crystal layer 36.

For example, the liquid crystal diffraction element refracts circularly polarized light as incidence light to be transmitted in a predetermined direction. In FIG. 11, the incidence light is left circularly polarized light.

In the portion shown in FIG. 11, a liquid crystal layer 36 includes three regions A0, A1, and A2 in order from the left side in FIG. 11, and the respective regions have different lengths A of single periods. Specifically, the length Λ of the single period decreases in order from the regions A0, A1, and A2. In addition, the regions A1 and A2 have a structure (hereinafter, also referred to as “twisted structure”) in which the optical axis is twisted in the thickness direction of the liquid crystal layer and rotates. The twisted angles of the regions may be the same as or different from each other and can be appropriately set depending on required performance. FIG. 11 shows an example in which the twisted angle of the region A1 in the thickness direction is less than the twisted angle of the region A2 in the thickness direction and the region A0 is a region not having the twisted structure (that is, the twisted angle is 0°).

The twisted angle is a twisted angle in the entire thickness direction.

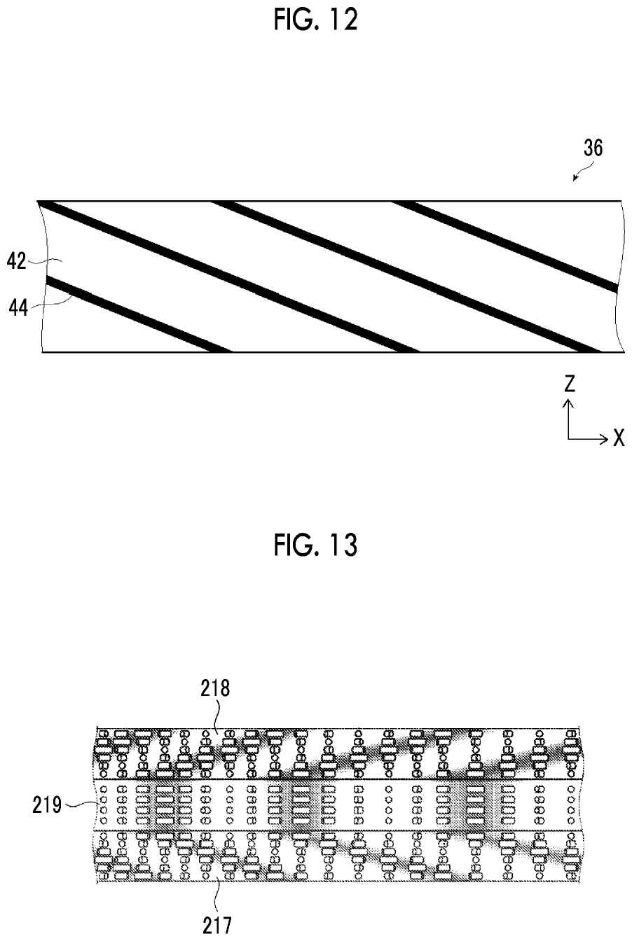

In a case where the liquid crystal layer has the twisted structure, as shown in FIG. 12, in a cross section observed with a scanning electron microscope (SEM), bright portions 42 and dark portions 44 are tilted with respect to a main surface of the liquid crystal layer 36.

In the liquid crystal diffraction element, in a case where left circularly polarized light LC1 is incident into the in-plane region A1 of the liquid crystal layer 36, as described above, the left circularly polarized light LC1 is refracted and transmitted at a predetermined angle in the arrangement axis D direction with respect to the incidence direction, that is, in the one in-plane direction in which the direction of the optical axis of the liquid crystal compound changes while continuously rotating. Likewise, in a case where left circularly polarized light LC2 is incident into the in-plane region A2 of the liquid crystal layer 36, the left circularly polarized light LC2 is refracted and transmitted at a predetermined angle in the arrangement axis D direction with respect to the incidence direction. Likewise, in a case where left circularly polarized light LC0 is incident into the in-plane region A0 of the liquid crystal layer 36, the left circularly polarized light LC0 is refracted and transmitted at a predetermined angle in the arrangement axis D direction with respect to the incidence direction.

Regarding the refraction angles from the liquid crystal layer 36, since a single period Λ_{A2} of the liquid crystal alignment pattern of the region A2 is shorter than a single period Λ_{A1} of the liquid crystal alignment pattern of the region A1, as shown in FIG. 11, a refraction angle θ_{A2} of transmitted light of the region A2 is more than a refraction angle θ_{A1} of transmitted light of the region A1 with respect to the incidence light. In addition, since a single period Λ_{A0} of the liquid crystal alignment pattern of the region A0 is longer than the single period Λ_{A1} of the liquid crystal alignment pattern of the region A₁, as shown in FIG. 11, a refraction angle θ_{A0} of transmitted light of the region A0 is less than the refraction angle θ_{A1} of transmitted light of the region A1 with respect to the incidence light.

With the configuration in which the liquid crystal alignment pattern Λ of the region decreases from the center side of the liquid crystal diffraction element to an end part thereof, light incident into the end part side can be refracted more than light incident into the vicinity of the center of the liquid crystal diffraction element, and a function as a positive lens that focuses light can be exhibited.

Here, in the diffraction of light by the liquid crystal layer having the liquid crystal alignment pattern in which the direction of the optical axis of the liquid crystal compound changes while continuously rotating in a plane, in a case where the diffraction angle increases, the diffraction efficiency may decrease.

Therefore, in a case where the liquid crystal layer has regions where lengths of the single periods over which the direction of the optical axis of the liquid crystal compound rotates by 180° in a plane are different from each other, the diffraction angle varies depending on light incidence positions. Therefore, there may be a difference in the amount of diffracted light depending on in-plane incidence positions. That is, a region where the brightness of light transmitted and diffracted may be low depending on in-plane incidence positions is present.

On the other hand, in the liquid crystal diffraction element, in a case where the liquid crystal layer has regions in which the optical axis is twisted in the thickness direction and rotates, a decrease in the diffraction efficiency of refracted light can be suppressed. Accordingly, in the liquid crystal diffraction element, it is preferable that the liquid crystal layer has regions in which the optical axis is twisted in a thickness direction of the optically-anisotropic layer and rotates, the regions having different magnitudes of twisted angles in the thickness direction.

Specifically, by setting the twisted angle in the thickness direction to be large in the region where the length of the single period Λ of the liquid crystal alignment pattern is short, the amounts of light reflected can be made to be uniform irrespective of in-plane incidence positions.

In addition, in the liquid crystal diffraction element, it is preferable that the optically-anisotropic layer has a region in which the magnitudes of the twisted angles in the thickness direction are 10° to 360°.

In the liquid crystal diffraction element, the twisted angle in the thickness direction may be appropriately set according to the single period Λ of the liquid crystal alignment pattern in a plane.

Here, in the example shown in FIG. 6, the liquid crystal diffraction element includes one liquid crystal layer, but the present invention is not limited thereto. The liquid crystal diffraction element may include two or more liquid crystal layers.

In addition, in a case where the liquid crystal diffraction element includes two or more liquid crystal layers, the liquid crystal diffraction element may further include liquid crystal layers having different directions (directions of the twisted angle) in which the optical axis is twisted in the thickness direction and rotates.

For example, liquid crystal layers may be laminated to be used, in which each of the liquid crystal layers has a liquid crystal alignment pattern in which a direction of an optical axis derived from a liquid crystal compound rotates in one in-plane direction, each of the liquid crystal layers has regions in which the optical axis is twisted in a thickness direction of the liquid crystal layer and rotates, the regions having different magnitudes of twisted angles of the rotation in a plane, and the liquid crystal layers have different directions in which the optical axis is twisted in the thickness direction and rotates.

This way, in a case where the liquid crystal diffraction element further includes liquid crystal layers having different directions in which the optical axis is twisted in the thickness direction and rotates, transmitted light of incidence light having various polarization states can be efficiently refracted in a region having a twisted angle in the thickness direction.

Here, in a case where the liquid crystal diffraction element includes liquid crystal layers having different directions in which the optical axis is twisted in the thickness direction and rotates, it is preferable that in-plane regions have the same twisted angle in the thickness direction.

However, the present invention is not limited to this configuration. In the liquid crystal diffraction element, the twisted angle in the thickness direction is not particularly limited and may be appropriately set according to the use of the optical element or the like.

In addition, in the liquid crystal layers having different directions in which the optical axis is twisted in the thickness direction and rotates, it is preferable that in-plane retardations Re(λ)=Δn_{λ}×d of the plurality of regions R of the liquid crystal layer with respect to incidence light having a wavelength of λ nm are the same.

However, the present invention is not limited to this configuration, and in the liquid crystal diffraction element, the in-plane retardation Re(λ)=Δn_{λ}×d of the plurality of regions R of the liquid crystal layer with respect to incidence light having a wavelength of λ nm is not particularly limited and may be appropriately set depending on the use of the optical element and the like.

In the liquid crystal diffraction element, the single period Λ in the alignment pattern of the liquid crystal layer is not particularly limited and may be appropriately set depending on the use of the optical element and the like.

(Method of Forming Regions Having Different Twisted Angles of Twisted Structure)

In the configuration in which the liquid crystal layer has regions having different twisted angles of the twisted structure, the chiral agent in which back isomerization, dimerization, isomerization, dimerization or the like occurs during light irradiation such that the helical twisting power (HTP) changes is used. By irradiating the liquid crystal composition with light having a wavelength at which the HTP of the chiral agent changes before or during the curing of the liquid crystal composition for forming the liquid crystal layer while changing the irradiation dose for each of the regions, the regions having different helical pitches can be formed.

For example, by using a chiral agent in which the HTP decreases during light irradiation, the HTP of the chiral agent decreases during light irradiation. Here, by changing the irradiation dose of light for each of the regions, for example, in a region that is irradiated with the light at a high irradiation dose, the decrease in HTP is large, the induction of helix is small, and thus the twisted angle of the twisted structure decreases. On the other hand, in a region that is irradiated with the light at a low irradiation dose, a decrease in HTP is small, and thus the twisted angle of the twisted structure is large.

The method of changing the irradiation dose of light for each of the regions is not particularly limited, and a method of irradiating light through a gradation mask, a method of changing the irradiation time for each of the regions, or a method of changing the irradiation intensity for each of the regions can be used.

The gradation mask refers to a mask in which a transmittance with respect to light for irradiation changes in a plane.

Here, in the present invention, in a case where the liquid crystal diffraction element is made to function as a convex lens, it is preferable that the liquid crystal diffraction element satisfies the following expression.

Φ(r)=(π/λ)[(r²+f²)^{1/2}−f]

Here, r represents a distance from the center of a concentric circle and is represented by the following expression “r=(x²+y²)^{1/2}”. x and y represent in-plane positions, and (x,y)=(0,0) represents the center of the concentric circle. Φ(r) represents an angle of the optical axis at the distance r from the center, λ represents a wavelength, and f represents a desired focal length.

In the present invention, depending on the uses of the liquid crystal diffraction element such as a case where it is desired to provide a light amount distribution in transmitted light, a configuration in which regions having partially different lengths of the single periods Λ in the one in-plane direction in which the optical axis continuously rotates are provided can also be used instead of the configuration in which the length of the single period Λ gradually changes in the one in-plane direction in which the optical axis continuously rotates. For example, as a method of partially changing the single period Λ, for example, a method of scanning and exposing the photo-alignment film to be patterned while freely changing a polarization direction of laser light to be gathered can be used.

Further, the liquid crystal diffraction element may include: a liquid crystal layer in which the single period Λ is homogeneous over the entire surface; and a liquid crystal layer in which regions where lengths of the single periods Λ are different from each other are provided.

Here, in the example shown in FIG. 5, the liquid crystal alignment pattern of the liquid crystal layer is a concentric circular pattern where the direction in which the direction of the optical axis of the liquid crystal compound changes while continuously rotating is provided in a radial shape from the center of the liquid crystal layer. However, the liquid crystal alignment pattern is not particularly limited as long as incident polarized light can be focused.

For example, the liquid crystal alignment pattern of the liquid crystal layer may be a concentric circular pattern in which the direction of the optical axis of the liquid crystal compound changes while continuously rotating is provided in an elliptical shape. That is, the liquid crystal alignment pattern may be a concentric circular pattern in which a line that connects liquid crystal compounds of which optical axes face the same direction has an elliptical shape. Alternatively, as long as incident polarized light can be focused, the liquid crystal alignment pattern may be a pattern deformed from the concentric circular pattern.

As described above, the liquid crystal diffraction element may include two or more liquid crystal layers. In this case, it is preferable that, in cross sectional images obtained by observing cross sections of at least two of the liquid crystal layers taken in a thickness direction parallel to the one in-plane direction in which the direction of the optical axis of the liquid crystal compound changes while continuously rotating with a scanning electron microscope, bright portions and dark portions derived from the direction of the optical axis are observed, and in the at least two liquid crystal layers, tilt angles of the bright portions and the dark portions with respect to the main surface of the liquid crystal layer are different from each other. In addition, it is preferable that the tilt directions of the bright portions and the dark portions are different from each other.

FIG. 13 shows an example of the liquid crystal diffraction element.

The liquid crystal diffraction element shown in FIG. 13 has a configuration in which a first liquid crystal layer 217, a second liquid crystal layer 219, and a third liquid crystal layer 218 are laminated in this order.

The first liquid crystal layer 217 and the third liquid crystal layer 218 have a liquid crystal alignment pattern in which a direction of an optical axis derived from a liquid crystal compound changes while continuously rotating in at least one in-plane direction and in which the optical axis is twisted and aligned in the thickness direction.

“The optical axis being twisted and aligned in the thickness direction” refers to a state where the direction of the optical axis arranged in the thickness direction from one main surface to another main surface of the liquid crystal layer relatively changes and is twisted and aligned in the one in-plane direction. The twisting property may be right-twisted or left-twisted and may be applied depending on a desired diffraction direction. The optical axis in the thickness direction is twisted by less than one turn, that is, the twisted angle is less than 360°. The twisted angle of the liquid crystal compound in the thickness direction is preferably about 10° to 200° and more about preferably 20° to 180°. In the cholesteric alignment, the twisted angle is 360° or more, and selective reflectivity in which specific circularly polarized light in a specific wavelength range is reflected is exhibited. In the present specification, “twisted alignment” does not include cholesteric alignment, and selective reflectivity does not occur in the liquid crystal layer having the twisted alignment.

In a case where a cross section of the liquid crystal layer having the liquid crystal alignment pattern is observed with an SEM, bright lines and dark lines shown in FIG. 13 are observed. As shown in FIG. 13 where the bright lines and the bright lines overlap each other, a period of the bright lines and the dark line matches with a period of the liquid crystal alignment pattern.

As shown in FIG. 13, in the first liquid crystal layer 217 and the third liquid crystal layer 218, the tilt angles of the bright lines and the dark lines with respect to the main surface of the liquid crystal layer are the same, and the tilt directions are different. Accordingly, in the first liquid crystal layer 217 and the third liquid crystal layer 218, the bright lines and the dark lines are vertically symmetrical (symmetrical with respect to a center line in the thickness direction).

In addition, the second liquid crystal layer 219 that is disposed between the first liquid crystal layer 217 and the third liquid crystal layer 218 has a liquid crystal alignment pattern in which a direction of an optical axis derived from a liquid crystal compound changes while continuously rotating in at least one in-plane direction and in which the optical axis is not twisted and aligned in the thickness direction. Accordingly, bright lines and dark lines of the second liquid crystal layer 219 are along the normal line of an interface of the second liquid crystal layer 219 and are not tilted.

The single periods in the liquid crystal alignment patterns of the first liquid crystal layer 217, the second liquid crystal layer 219, and the third liquid crystal layer 218 vary depending on in-plane regions. At the same in-plane position, the single periods in the liquid crystal alignment patterns of the first liquid crystal layer 217, the second liquid crystal layer 219, and the third liquid crystal layer 218 are the same.

Accordingly, in the liquid crystal diffraction element including the first liquid crystal layer 217, the second liquid crystal layer 219, and the third liquid crystal layer 218, the bright lines and the dark lines are vertically symmetrical.

In a case where the optical axis is not twisted and aligned in the thickness direction as in the second liquid crystal layer 219, the diffraction efficiency with respect to light incident from the normal direction is high, but the diffraction efficiency with respect to light incident from an oblique direction is low. On the other hand, in the first liquid crystal layer 217 and the third liquid crystal layer 218, the diffraction efficiency with respect to light incident from an oblique direction can be improved.

Accordingly, in the liquid crystal diffraction element where the liquid crystal layers are laminated, a change in diffraction efficiency depending on the incidence angle can be reduced, and the average diffraction efficiency can be improved.

In the example shown in FIG. 13, the liquid crystal diffraction element has the configuration in which the bright lines and the dark lines are vertically symmetrical. However, the present invention is not limited to this configuration.

For example, the first liquid crystal layer 217, the second liquid crystal layer 219, and the third liquid crystal layer 218 may be configured such that changes in the twisted angle in the thickness direction parallel to the one in-plane direction in which the direction of the optical axis derived from the liquid crystal compound changes are different. As a result, the bright portions and the dark portions are vertically symmetrical on the center side of the liquid crystal diffraction element and the bright portions and the dark portions are vertically asymmetrical on the center side of the liquid crystal diffraction element.

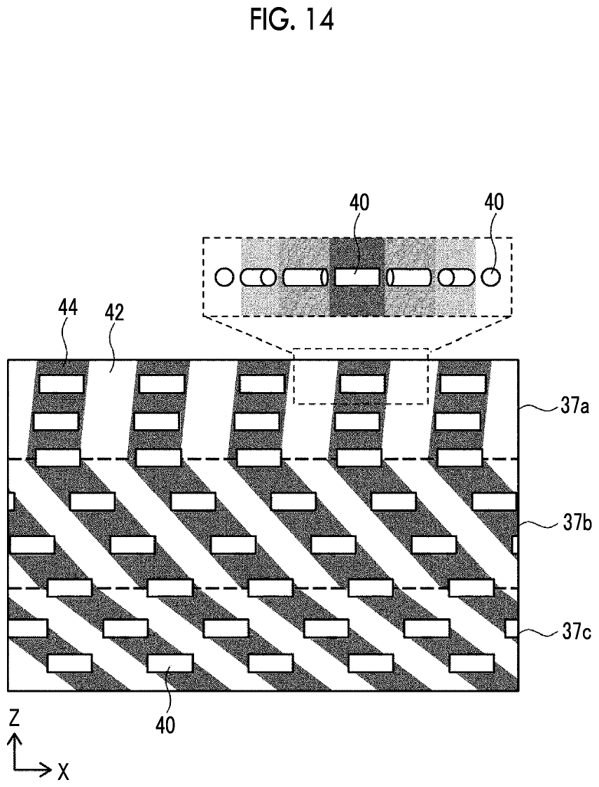

In addition, as in the example shown in FIG. 14, a first liquid crystal layer 37a, a second liquid crystal layer 37b, and a third liquid crystal layer 37c may be configured such that bright portions and dark portions are tilted, have different tilt angles, and thus are vertically asymmetrical.

Here, in the present invention, as shown in FIGS. 13 and 14, a liquid crystal diffraction element can be preferably used, in which the liquid crystal layer has bright portions and dark portions extending from one surface to another surface and each of the dark portions has two or more inflection points of angle in an SEM image, and the liquid crystal layer has regions where tilt directions of the dark portions are different from each other in the thickness direction.

In the examples shown in FIGS. 13 and 14, the liquid crystal layer has a stripe pattern of bright portions and dark portions, and the tilt angle of one dark portion with respect to the surface changes at two positions in the thickness direction. That is, each of the dark portions has two inflection points. In addition, in all of the dark portions, a tilt direction in the upper region in the drawing and a tilt direction in the lower region in the drawing are opposite to each other. That is, each of the dark portions has regions where the tilt directions are different.

In addition, it is preferable that, in the liquid crystal layer, the number of inflection points where the tilt direction of the dark portion is folded is an odd number. In the example shown in FIG. 14, the number of inflection points where the tilt direction of the dark portion is folded is one.

It is preferable that an average tilt angle of the dark portion in the liquid crystal layer gradually changes in the one in-plane direction. The average tilt angle of the dark portions refers to an angle of a line segment that connects a point on one surface of one dark portion and a point on another surface of the dark portion with respect to the main surface of the liquid crystal layer.

In addition, it is preferable that a difference Δn₅₅₀ in refractive index generated by refractive index anisotropy of the liquid crystal layer is 0.2 or more.

Another example of the configuration in which the liquid crystal diffraction element includes two or more liquid crystal layers and tilt angles of bright portions and dark portions in at least two of the liquid crystal layers are different from each other is described in WO2020/066429A.

The image display unit according to the embodiment of the present invention described above can be suitably used as an image display unit of a head-mounted display.

### EXAMPLES

Hereinafter, the characteristics of the present invention will be described in detail using Examples and Comparative Examples. Materials, used amounts, ratios, treatment details, treatment procedures, and the like shown in the following examples can be appropriately changed within a range not departing from the scope of the present invention. Accordingly, the scope of the present invention is not limited to the following specific examples.

### Example 1

<Preparation of Polarization Diffraction Element>

(Support)

Glass was used as the support.

(Formation of Alignment Film)

The following coating liquid for forming an alignment film was continuously applied to the support by spin coating. The support on which the coating film of the coating liquid for forming an alignment film was formed was dried using a hot plate at 60° C. for 60 seconds. As a result, an alignment film was formed.

Coating Liquid for Forming Alignment Film

| | | |
|---|---|---|
| Material A for photo-alignment | 1.00 | parts by mass |
| Water | 16.00 | parts by mass |
| Butoxyethanol | 42.00 | parts by mass |
| Propylene glycol monomethyl ether | 42.00 | parts by mass |

Material A for Photo-Alignment-

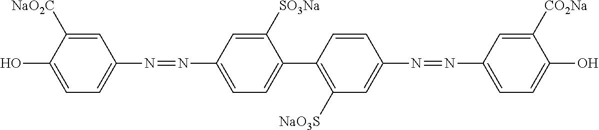

(Exposure of Alignment Film)

The alignment film was exposed using the exposure device shown in FIG. 8 to form an alignment film P-1 having an alignment pattern.

In the exposure device, a laser that emits laser light having a wavelength (325 nm) was used as the laser. The exposure amount of the interference light was 1000 mJ/cm². By using the exposure device shown in FIG. 8, the single period of the alignment pattern gradually decreased toward the outer direction.

(Formation of Liquid Crystal Layer)

As the liquid crystal composition forming the first liquid crystal layer, the following composition A-1 was prepared.

Composition A-1

| | | |
|---|---|---|
| Liquid crystal compound L-1 | 100.00 | parts by mass |
| Chiral agent M-1 | 0.36 | parts by mass |
| Polymerization initiator (IRGACURE (registered trade name) 907, | 3.00 | parts by mass |
| manufactured by BASF SE) | | |
| Photosensitizer (KAYACURE DETX-S, manufactured by | 1.00 | parts by mass |
| Nippon Kayaku Co., Ltd.) | | |
| Leveling agent T-1 | 0.08 | parts by mass |
| Methyl ethyl ketone | 1050.00 | parts by mass |

Liquid Cystal Compound L-1 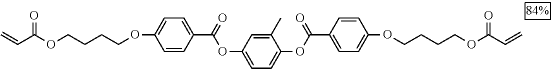 [SMILES: C=CC(=O)OCCCCOc1ccc(C(=O)Oc2ccc(OC(=O)c3ccc(OCCCCOC(=O)C=C)cc3)c(C)c2)cc1] 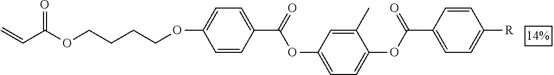 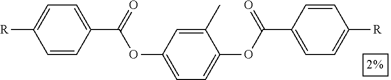 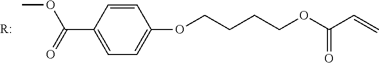
Chiral Agent M-1 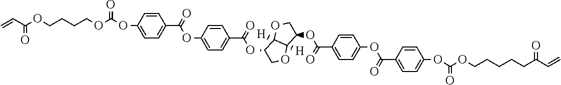 [SMILES: C=CC(=O)CCCCCOC(=O)Oc1ccc(C(=O)Oc2ccc(C(=O)O[C@@H]3CO[C@H]4[C@@H]3OC[C@@H]4OC(=O)c3ccc(OC(=O)c4ccc(OC(=O)OCCCCOC(=O)C=C)cc4)cc3)cc2)cc1]
Leveling Agent T-1

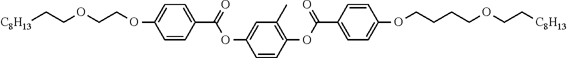

The liquid crystal layer was formed by applying multiple layers of the composition A-1 to the alignment film P-1. The application of the multiple layers refers to repetition of the following processes including: preparing a first liquid crystal immobilized layer by applying the composition A-1 for forming the first layer to the alignment film, heating the composition A-1, cooling the composition A-1, and irradiating the composition A-1 with ultraviolet light for curing; and preparing a second or subsequent liquid crystal immobilized layer by applying the composition A-1 for forming the second or subsequent layer to the formed liquid crystal immobilized layer, heating the composition A-1, cooling the composition A-1, and irradiating the composition A-1 with ultraviolet light for curing as described above. Even in a case where the liquid crystal layer was formed by the application of the multiple layers such that the total thickness of the liquid crystal layer was large, the alignment direction of the alignment film was reflected from a lower surface of the liquid crystal layer to an upper surface thereof.

Regarding the first liquid crystal layer, the following composition A-1 was applied to the alignment film P-1 to form a coating film, the coating film was heated to 80° C. using a hot plate, the coating film was irradiated with ultraviolet light having a wavelength of 365 nm at an irradiation dose of 300 mJ/cm² using a high-pressure mercury lamp in a nitrogen atmosphere. As a result, the alignment of the liquid crystal compound was immobilized.

Regarding the second or subsequent liquid crystal layer, the composition was applied to the first liquid crystal layer, and the applied composition was heated, cooled, and irradiated with ultraviolet light for curing under the same conditions as described above. As a result, a liquid crystal immobilized layer was prepared. This way, by repeating the application multiple times until the total thickness reached a desired film thickness, and the first liquid crystal layer was formed.

A complex refractive index of the cured layer of a liquid crystal composition A1 was obtained by applying the liquid crystal composition A1 a support with an alignment film for retardation measurement that was prepared separately, aligning the director of the liquid crystal compound to be parallel to the substrate, irradiating the liquid crystal compound with ultraviolet irradiation for immobilization to obtain a liquid crystal immobilized layer (cured layer), and measuring the retardation value and the film thickness of the liquid crystal immobilized layer. An can be calculated by dividing the retardation value by the film thickness. The retardation value was measured at a desired wavelength using Axoscan (manufactured by Axometrix Inc.), and the film thickness was measured using a scanning electron microscope (SEM).

Finally, in the first liquid crystal layer, Δn₅₅₀×thickness (Re(550)) of the liquid crystals was 160 nm, and it was verified using a polarization microscope that concentric circular (radial) periodic alignment occurred on the surface as shown in FIG. 5. In the liquid crystal alignment pattern of the first liquid crystal layer, the period decreased toward the outer direction. In addition, the twisted angle in the thickness direction of the first liquid crystal layer was right-twisted and was 80° in a plane. Hereinafter, unless specified otherwise, “Δn₅₅₀×d” and the like were measured as described above.

As the liquid crystal composition forming the second liquid crystal layer, the following composition A-2 was prepared.

Composition A-2

| | | |
|---|---|---|
| Liquid crystal compound L-1 | 100.00 | parts by mass |
| Polymerization initiator (IRGACURE | 3.00 | parts by mass |
| (registered trade name) 907, manufactured | | |
| by BASF SE) | | |
| Photosensitizer (KAYACURE DETX-S, | 1.00 | part by mass |
| manufactured by Nippon Kayaku Co., Ltd.) | | |
| Leveling agent T-1 | 0.08 | parts by mass |
| Methyl ethyl ketone | 1050.00 | parts by mass |

The second liquid crystal layer was formed on the first liquid crystal layer using the same method as that of the first liquid crystal layer, except that the film thickness of the liquid crystal layer was adjusted using the composition A-2.

Finally, in the second liquid crystal layer, Δn₅₅₀×thickness (Re(550)) of the liquid crystals was 330 nm, and it was verified using a polarization microscope that concentric circular (radial) periodic alignment occurred on the surface as shown in FIG. 5. In the liquid crystal alignment pattern of the second liquid crystal layer, the period decreased toward the outer direction. In addition, the twisted angle in the thickness direction of the second liquid crystal layer was 0° in a plane.

As the liquid crystal composition forming the third liquid crystal layer, the following composition A-3 was prepared.

Composition A-3

| | | |
|---|---|---|
| Liquid crystal compound L-1 | 100.00 | parts by mass |
| Chiral agent H-1 | 0.63 | parts by mass |
| Polymerization initiator (IRGACURE (registered trade name) 907, | 3.00 | parts by mass |
| manufactured by BASF SE) | | |
| Photosensitizer (KAYACURE DETX-S, manufactured by Nippon Kayaku | 1.00 | parts by mass |
| Co., Ltd.) | | |
| Leveling agent T-1 | 0.08 | parts by mass |
| Methyl ethyl ketone | 1050.00 | parts by mass |

Chiral Agent H-l

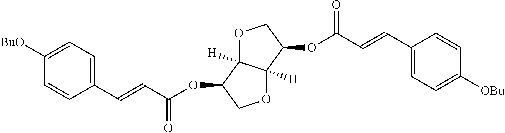

The third liquid crystal layer was formed on the second liquid crystal layer using the same method as that of the first liquid crystal layer, except that the film thickness of the liquid crystal layer was adjusted using the composition A-3.

Finally, in the third liquid crystal layer, Δn₅₅₀×thickness (Re(550)) of the liquid crystals was 160 nm, and it was verified using a polarization microscope that concentric circular (radial) periodic alignment occurred on the surface as shown in FIG. 5. In the liquid crystal alignment pattern of the third liquid crystal layer, the period decreased toward the outer direction. In addition, the twisted angle in the thickness direction of the liquid crystal layer was left-twisted and was 80° in a plane.

By causing parallel light to be incident into the liquid crystal diffraction element including the first to third liquid crystal layers, the focal length of focused emitted light was measured. The focal length was 30 mm.

<Preparation of Retardation Plate>

A film including a cellulose acylate film, an alignment film, and an optically-anisotropic layer C was obtained using the same method as a positive A plate described in paragraphs “0102” to “0126” of JP2019-215416A.

The optically-anisotropic layer C was the positive A plate (retardation plate), and the thickness of the positive A plate was controlled such that Re(550) was 138 nm.

<Preparation of Image Display Unit>

An image display unit including a first linearly polarizing plate, a first retardation plate (λ/4 plate), a liquid crystal diffraction element, a second retardation plate (λ/4 plate), and a linearly polarizing plate was prepared (refer to FIG. 1). Oculus Rift S manufactured by Facebook Technologies, LLC as a commercially available head-mounted display was disassembled, a display thereof was used as the image display apparatus, and a linearly polarizing plate bonded to the surface of the display was used as the first linearly polarizing plate and the second linearly polarizing plate. The first linearly polarizing plate was disposed on the image display apparatus side such that the angle of the absorption axis thereof was 90°. The first retardation plate was disposed such that the slow axis was 45°. The second retardation plate was disposed such that the slow axis was −45°. The second linearly polarizing plate was disposed such that the angle of the absorption axis thereof was 0°. The axis angle described herein was an angle with respect to(0°) a horizontal direction of the head-mounted display, and in a case where the image display unit was seen from the visible side, a clockwise direction was positive.

In addition, the distance between the image display apparatus and the liquid crystal diffraction element was 30 mm.

### Example 2

An image display unit was prepared using the same method as that of Example 1, except that during the preparation of the liquid crystal diffraction element, the alignment pattern to be formed on the alignment film P-1 was changed, the focal length was changed to 15 mm, and the distance of the image display apparatus and the liquid crystal diffraction element was changed to 15 mm.

### Example 3

An image display unit was prepared using the same method as that of Example 1, except that during the preparation of the liquid crystal diffraction element, the alignment pattern to be formed on the alignment film P-1 was changed, the focal length was changed to 10 mm, and the distance of the image display apparatus and the liquid crystal diffraction element was changed to 10 mm.

### Comparative Example 1

A Fresnel lens was disposed on the display surface of the image display apparatus to prepare an image display unit. The focal length of the Fresnel lens was 40 mm. The distance between the image display apparatus and the Fresnel lens was 40 mm.

As the Fresnel lens, that attached to Oculus Rift S was used.

### Comparative Example 2

An optical element was prepared using a first absorptive linearly polarizing plate, a first retardation plate (λ/4 plate), a partially reflecting mirror, a second retardation plate (λ/4 plate), a reflective linearly polarizing plate, and a second absorptive linearly polarizing plate, and an image display unit as a head-mounted display was prepared. Oculus Rift S manufactured by Facebook Technologies, LLC as a commercially available head-mounted display was disassembled, and a display and an absorptive linearly polarizing plate bonded to a surface of the display were disposed such that an absorption axis angle of the first absorptive linearly polarizing plate was 90°. As the partially reflecting mirror, an aluminum film was formed by sputtering on a convex surface of a lens having a diameter of 5 cm and a curvature radius of 10 cm such that the transmittance was 50% and the reflectivity was 50%. That is, the partially reflecting mirror had a curved shape. As the second reflective linearly polarizing plate, DBEF manufactured by 3M was used and disposed such that a transmission axis angle was 90°. The second absorptive linearly polarizing plate was disposed on a visible side of the second reflective linearly polarizing plate such that an absorption axis angle was 0°. In addition, the first retardation plate and the second retardation plate were disposed such that slow axes were 45° and −45°, respectively.

The focal length of the partially reflecting mirror was 20 mm. The distance between the image display apparatus and the partially reflecting mirror was 20 mm.

### Comparative Example 3

An image display unit was prepared using the same method as that of Example 1, except that it did not include the second retardation plate and the second linearly polarizing plate.

[Evaluation]

<Evaluation of Light Utilization Efficiency of Image Display Unit>

The display in the image display unit was removed, and a light source for evaluation was disposed. As the light source for evaluation, a laser pointer (wavelength: 532 nm) was used. Using the laser pointer, light was caused to be incident (incidence light) from the first linearly polarizing plate side, and the intensity of emitted light was measured using a power meter. An intensity ratio between the intensity of the incidence light and the intensity of the emitted light was evaluated based on the following standards.

A: the intensity ratio was 0.7 or more.

B: the intensity ratio was 0.5 or more and less than 0.7.

C: the intensity ratio was less than 0.5.

<Image Quality Evaluation 1>

As in the evaluation of the light utilization efficiency, using the laser pointer, light was caused to be incident from the first linearly polarizing plate side, paper was disposed at the position of the focal length, and light displayed on the paper was observed to perform the evaluation based on the following standards.

A: a light spot was observed at one focal point.

B: light was also observed at a position other than the focal point.

<Image Quality Evaluation 2>

The display in the image display unit was turned on, and a displayed image was observed to perform the evaluation based on the following standards.

A: light streak was not observed.

B: light streak was observed.

The results are shown in Table 1.

TABLE 1

| | | | | Evaluation | | |
|---|---|---|---|---|---|---|
| | | | Presence or | Light | | |
| | | Focal | absence of | utilization | Image | Image |
| | Kind of lens | length | polarizing plate | efficiency | quality 1 | quality 2 |
| Example 1 | Liquid crystal | 30 mm | Present | A | A | A |
| | diffractive lens | | | | | |
| Example 2 | Liquid crystal | 15 mm | Present | A | A | A |
| | diffractive lens | | | | | |
| Example 3 | Liquid crystal | 10 mm | Present | A | A | A |
| | diffractive lens | | | | | |
| Comparative | Fresnel lens | 40 mm | — | A | A | B |
| Example 1 | | | | | | |
| Comparative | Partially | 20 mm | — | C | A | A |
| Example 2 | reflecting mirror | | | | | |
| Comparative | Liquid crystal | 30 mm | Absent | A | B | A |
| Example 3 | diffractive lens | | | | | |

It can be seen from Table 1 that, in Examples 1 to 3 according to the present invention, the light utilization efficiency was higher and the image quality of the displayed image was higher than those of Comparative Examples.

In Comparative Example 1, light streak caused by the groove structure of the Fresnel lens was visually recognized in the display image, and the image quality was poor.

In Comparative Example 2, the light utilization efficiency was low.

In Comparative Example 3, light not diffracted by the liquid crystal diffraction element was emitted, and thus the image quality decreased.

[Example 1-A2]

A liquid crystal diffraction element was prepared using the same method as that of Example 1, except that the liquid crystal compound L-1 was changed to a liquid crystal compound L-2, the addition amounts of the chiral agent M-1 and the chiral agent H-1 were adjusted, and the film thickness of the liquid crystal layer was adjusted, and an image display unit according to Example 1-A2 was prepared using the prepared liquid crystal diffraction element.

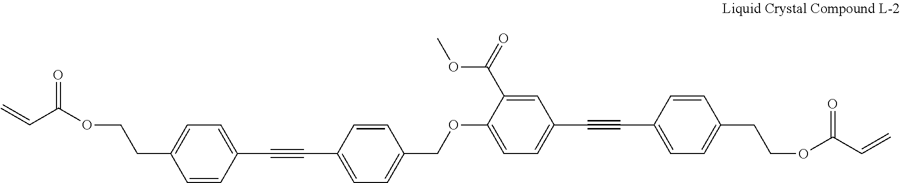 [SMILES: C=CC(=O)OCCc1ccc(C#Cc2ccc(COc3ccc(C#Cc4ccc(CCOC(=O)C=C)cc4)cc3C(=O)OC)cc2)cc1]

Finally, in the first liquid crystal layer, Δn₅₅₀×thickness (Re(550)) of the liquid crystals was 160 nm, and it was verified using a polarization microscope that concentric circular (radial) periodic alignment occurred on the surface as shown in FIG. 5. In the liquid crystal alignment pattern of the first liquid crystal layer, the period decreased toward the outer direction. In addition, the twisted angle in the thickness direction of the first liquid crystal layer was right-twisted and was 80° in a plane.

Finally, in the second liquid crystal layer, Δn₅₅₀×thickness (Re(550)) of the liquid crystals was 330 nm, and it was verified using a polarization microscope that concentric circular (radial) periodic alignment occurred on the surface as shown in FIG. 5. In the liquid crystal alignment pattern of the second liquid crystal layer, the period decreased toward the outer direction. In addition, the twisted angle in the thickness direction of the second liquid crystal layer was 0° in a plane.

Finally, in the third liquid crystal layer, Δn₅₅₀×thickness (Re(550)) of the liquid crystals was 160 nm, and it was verified using a polarization microscope that concentric circular (radial) periodic alignment occurred on the surface as shown in FIG. 5. In the liquid crystal alignment pattern of the third liquid crystal layer, the period decreased toward the outer direction. In addition, the twisted angle in the thickness direction of the liquid crystal layer was left-twisted and was 80° in a plane.

By causing parallel light to be incident into the liquid crystal diffraction element including the first to third liquid crystal layers, the focal length of focused emitted light was measured. The focal length was 30 mm.

### Example 2-A2

An image display unit was prepared using the same method as that of Example 1-A2, except that during the preparation of the liquid crystal diffraction element, the alignment pattern to be formed on the alignment film P-1 was changed, the focal length was changed to 15 mm, and the distance of the image display apparatus and the liquid crystal diffraction element was changed to 15 mm.

### Example 3-A2

An image display unit was prepared using the same method as that of Example 1-A2, except that during the preparation of the liquid crystal diffraction element, the alignment pattern to be formed on the alignment film P-1 was changed, the focal length was changed to 10 mm, and the distance of the image display apparatus and the liquid crystal diffraction element was changed to 10 mm.

### Example 1-A3

A liquid crystal diffraction element was prepared using the same method as that of Example 1, except that the liquid crystal compound L-1 was changed to a liquid crystal compound L-3, the addition amounts of the chiral agent M-1 and the chiral agent H-1 were adjusted, the heating temperature of the coating film during the formation of the liquid crystal layer was changed to 55° C., and the film thickness of the liquid crystal layer was adjusted, and an image display unit according to Example 1-A3 was prepared using the prepared liquid crystal diffraction element.

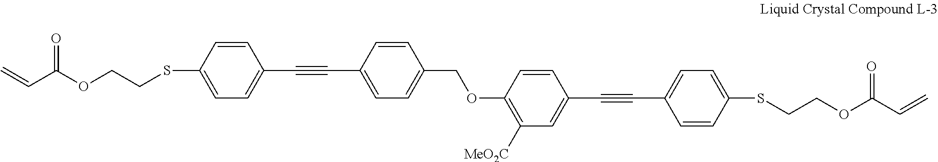 [SMILES: C=CC(=O)OCCSc1ccc(C#Cc2ccc(COc3ccc(C#Cc4ccc(SCCOC(=O)C=C)cc4)cc3C(=O)OC)cc2)cc1]

Finally, in the first liquid crystal layer, Δn₅₅₀×thickness (Re(550)) of the liquid crystals was 160 nm, and it was verified using a polarization microscope that concentric circular (radial) periodic alignment occurred on the surface as shown in FIG. 5. In the liquid crystal alignment pattern of the first liquid crystal layer, the period decreased toward the outer direction. In addition, the twisted angle in the thickness direction of the first liquid crystal layer was right-twisted and was 80° in a plane.

Finally, in the second liquid crystal layer, Δn₅₅₀×thickness (Re(550)) of the liquid crystals was 330 nm, and it was verified using a polarization microscope that concentric circular (radial) periodic alignment occurred on the surface as shown in FIG. 5. In the liquid crystal alignment pattern of the second liquid crystal layer, the period decreased toward the outer direction. In addition, the twisted angle in the thickness direction of the second liquid crystal layer was 0° in a plane.

Finally, in the third liquid crystal layer, Δn₅₅₀×thickness (Re(550)) of the liquid crystals was 160 nm, and it was verified using a polarization microscope that concentric circular (radial) periodic alignment occurred on the surface as shown in FIG. 5. In the liquid crystal alignment pattern of the third liquid crystal layer, the period decreased toward the outer direction. In addition, the twisted angle in the thickness direction of the liquid crystal layer was left-twisted and was 80° in a plane.

By causing parallel light to be incident into the liquid crystal diffraction element including the first to third liquid crystal layers, the focal length of focused emitted light was measured. The focal length was 30 mm.

### Example 2-A3

An image display unit was prepared using the same method as that of Example 1-A3, except that during the preparation of the liquid crystal diffraction element, the alignment pattern to be formed on the alignment film P-1 was changed, the focal length was changed to 15 mm, and the distance of the image display apparatus and the liquid crystal diffraction element was changed to 15 mm.

### Example 3-A3

An image display unit was prepared using the same method as that of Example 1-A3, except that during the preparation of the liquid crystal diffraction element, the alignment pattern to be formed on the alignment film P-1 was changed, the focal length was changed to 10 mm, and the distance of the image display apparatus and the liquid crystal diffraction element was changed to 10 mm.

Δn₅₅₀ of the liquid crystal layers (liquid crystal compounds) in Examples 1 to 3 was 0.15, Δn₅₅₀ of the liquid crystal layers in Examples 1-A2 to 3-A2 was 0.25, and Δn₅₅₀ of the liquid crystal layers in Examples 1-A3 to 3-A3 was 0.32.

[Evaluation]

<Evaluation of Light Utilization Efficiency of Image Display Unit>

The display in the image display unit was removed, and a light source for evaluation was disposed. As the light source for evaluation, a laser pointer (wavelength: 532 nm) was used. Using the laser pointer, light was caused to be incident (incidence light) from the first linearly polarizing plate side, and the intensity of emitted light was measured using a power meter. An intensity ratio between the intensity of the incidence light and the intensity of the emitted light was obtained.

At positions of 5 mm and 15 mm from the center of the concentric circle of the prepared liquid crystal diffraction element, the measurement was performed while changing the incidence angle of ±40° (at intervals of 10°) from the normal direction(0°) of the liquid crystal diffraction element.

The average values of the intensity ratios (light utilization efficiencies) measured at the different incidence angles were calculated, and Examples 1 to 3, Examples 1-A2 to 3-A2, and Examples 1-A3 to 3-A3 were compared.

As a result of the evaluation, as compared to Example 1, the light utilization efficiency (average value) of Example 1-A2 was improved, and the light utilization efficiency (average value) of Example 1-A3 was further improved.

Likewise, as compared to Example 2, the light utilization efficiency (average value) of Example 2-A2 was improved, and the light utilization efficiency (average value) of Example 2-A3 was further improved.

As compared to Example 3, the light utilization efficiency (average value) of Example 3-A2 was improved, and the light utilization efficiency (average value) of Example 3-A3 was further improved.

It can be seen from the above results that, as the difference Δn₅₅₀ in refractive index of the liquid crystal layer of the liquid crystal diffraction element increases, the light utilization efficiency with respect to the different incidence angles is improved.

### Example 1-B1

(Formation of Liquid Crystal Layer)

As the liquid crystal composition forming the first liquid crystal layer, the following composition B-1 was prepared.

Composition B-1

| | | |
|---|---|---|
| Liquid crystal compound L-1 | 100.00 | parts by mass |
| Chiral agent C-3 | 0.23 | parts by mass |
| Chiral agent C-4 | 0.82 | parts by mass |
| Polymerization initiator (IRGACURE-OXE01, | 1.00 | parts by mass |
| manufactured by BASF SE) | | |
| Leveling agent T-1 | 0.08 | parts by mass |
| Methyl ethyl ketone | 1050.00 | parts by mass |

Chiral Agent C-3 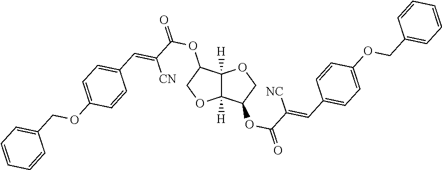 [SMILES: N#C/C(=C\c1ccc(OCc2ccccc2)cc1)C(=O)OC1CO[C@H]2[C@@H]1OC[C@H]2OC(=O)/C(C#N)=C/c1ccc(OCc2ccccc2)cc1]
Chiral Agent C-4

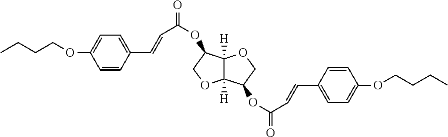 [SMILES: CCCCOc1ccc(/C=C/C(=O)O[C@@H]2CO[C@H]3[C@@H]2OC[C@H]3OC(=O)/C=C/c2ccc(OCCCC)cc2)cc1]

As the liquid crystal composition for forming the second liquid crystal layer, a composition B-2 was prepared using the same method as that of the composition B-1 according to Example 1-B1, except that the amount of chiral agent C-3 was changed to 0.54 parts by mass and the amount of the chiral agent C-4 was changed to 0.62 parts by mass.

As the liquid crystal composition for forming the third liquid crystal layer, a composition B-3 was prepared using the same method as that of the composition B-1 according to Example 1-B1, except that the amount of chiral agent C-3 was changed to 0.48 parts by mass and the chiral agent C-4 was not added.

First, the first liquid crystal layer was formed by applying multiple layers of the composition B-1 to the alignment film P-1.

First, in order to form the first layer, the composition B-1 was applied to the alignment film P-1, and the coating film was heated to 80° C. on a hot plate. Next, the coating film was irradiated with ultraviolet light having a wavelength of 365 nm using a LED-UV exposure device. At this time, the coating film was irradiated while changing the irradiation dose of ultraviolet light in a plane. Specifically, the coating film was irradiated by changing the irradiation dose in a plane such that the irradiation dose increased from the center portion toward an end part. Next, the coating film heated on a hot plate at 80° C. was irradiated with ultraviolet light having a wavelength of 365 nm at an irradiation dose of 300 mJ/cm² using a high-pressure mercury lamp in a nitrogen atmosphere. As a result, the alignment of the liquid crystal compound was immobilized.

Regarding the second or subsequent liquid crystal layer, the composition was applied to the liquid crystal immobilized layer, and then a liquid crystal immobilized layer was prepared under the same conditions as described above. This way, by repeating the application multiple times until the total thickness reached a desired film thickness, and the first liquid crystal layer was formed.

Finally, in the first liquid crystal layer, Δn₅₅₀×thickness (Re(550)) of the liquid crystals was 160 nm, and it was verified using a polarization microscope that concentric circular (radial) periodic alignment occurred on the surface as shown in FIG. 5. This liquid crystal layer had a liquid crystal alignment pattern where the period decreased toward the outer direction. Regarding the twisted angle in the thickness direction of the liquid crystal layer, the twisted angle at the position at a distance of about 5 mm from the center was left-twisted and 80° (−80°), the twisted angle at the position at a distance of about 15 mm from the center was left-twisted and 115° (−115°), and the twisted angle increased toward the outer direction.

As a result, the liquid crystal layer where the twisted angle changed in a plane was formed.

Next, the second liquid crystal layer was formed by applying multiple layers of the composition B-2 to the first liquid crystal layer.

The composition B-2 was applied to the first liquid crystal layer, and the liquid crystal layer was formed using the same method as that of the first liquid crystal layer according to Example 1-B1, except that the irradiation dose of ultraviolet light with which the coating film was irradiated changed from the center portion toward the end part (the irradiation dose increased from the center portion toward the end part) such that the total thickness was a desired film thickness.

Regarding the second or subsequent liquid crystal layer, the composition was applied to the liquid crystal immobilized layer, and then a liquid crystal immobilized layer was prepared under the same conditions as described above. This way, by repeating the application multiple times until the total thickness reached a desired film thickness, and the second liquid crystal layer was formed.

Finally, in the second liquid crystal layer, Δn₅₅₀×thickness (Re(550)) of the liquid crystals was 330 nm, and it was verified using a polarization microscope that concentric circular (radial) periodic alignment occurred on the surface as shown in FIG. 5. This liquid crystal layer had a liquid crystal alignment pattern where the period decreased toward the outer direction. Regarding the twisted angle in the thickness direction of the liquid crystal layer, the twisted angle at the position at a distance of about 5 mm from the center was left-twisted and 6° (−6°), the twisted angle at the position at a distance of about 15 mm from the center was left-twisted and 76° (−76°), and the twisted angle increased toward the outer direction.

As a result, the liquid crystal layer where the twisted angle changed in a plane was formed.

Next, the third liquid crystal layer was formed by applying multiple layers of the composition B-3 to the second liquid crystal layer.

The composition B-3 was applied to the second liquid crystal layer, and the liquid crystal layer was formed using the same method as that of the first liquid crystal layer according to Example 1-B1, except that the irradiation dose of ultraviolet light with which the coating film was irradiated changed from the center portion toward the end part (the irradiation dose increased from the center portion toward the end part) such that the total thickness was a desired film thickness.

Regarding the second or subsequent liquid crystal layer, the composition was applied to the liquid crystal immobilized layer, and then a liquid crystal immobilized layer was prepared under the same conditions as described above. This way, by repeating the application multiple times until the total thickness reached a desired film thickness, and the third liquid crystal layer was formed.

Finally, in the third liquid crystal layer, Δn₅₅₀×thickness (Re(550)) of the liquid crystals was 160 nm, and it was verified using a polarization microscope that concentric circular (radial) periodic alignment occurred on the surface as shown in FIG. 5. This liquid crystal layer had a liquid crystal alignment pattern where the period decreased toward the outer direction. Regarding the twisted angle in the thickness direction of the liquid crystal layer, the twisted angle at the position at a distance of about 5 mm from the center was right-twisted and 80° (twisted angle: 80°), the twisted angle at the position at a distance of about 15 mm from the center was left-twisted and 48° (twisted angle: 48°), and the twisted angle decreased toward the outer direction.

As a result, a liquid crystal layer including the first liquid crystal layer to the third liquid crystal layer was formed.

In a case where a cross section of the prepared optically-anisotropic layer was observed with an SEM, bright portions and dark portions had a shape in which the dark portion had two inflection points and the average tilt angle increased from the center toward the outer direction.

In addition, by causing parallel light to be incident into the liquid crystal diffraction element including the first to third liquid crystal layers, the focal length of focused emitted light was measured. The focal length was 30 mm.

### Example 2-B1

An image display unit was prepared using the same method as that of Example 1-B1, except that during the preparation of the liquid crystal diffraction element, the alignment pattern to be formed on the alignment film P-1 was changed, the focal length was changed to 15 mm, and the distance of the image display apparatus and the liquid crystal diffraction element was changed to 15 mm.

### Example 3-B1

An image display unit was prepared using the same method as that of Example 1-B1, except that during the preparation of the liquid crystal diffraction element, the alignment pattern to be formed on the alignment film P-1 was changed, the focal length was changed to 10 mm, and the distance of the image display apparatus and the liquid crystal diffraction element was changed to 10 mm.

### Example 1-B2

A liquid crystal diffraction element was prepared using the same method as that of Example 1-B1, except that the liquid crystal compound L-1 was changed to a liquid crystal compound L-2, the addition amounts of the chiral agent C-3 and the chiral agent C-4 were adjusted, and the irradiation dose of ultraviolet light with which the coating film was irradiated during the preparation of the liquid crystal layer changed from the center portion toward the end part was adjusted to adjust the film thickness of the liquid crystal layer, and an image display unit according to Example 1-B2 was prepared using the prepared liquid crystal diffraction element.

Finally, in the first liquid crystal layer, Δn₅₅₀×thickness (Re(550)) of the liquid crystals was 160 nm, and it was verified using a polarization microscope that concentric circular (radial) periodic alignment occurred on the surface as shown in FIG. 5. This liquid crystal layer had a liquid crystal alignment pattern where the period decreased toward the outer direction. Regarding the twisted angle in the thickness direction of the liquid crystal layer, the twisted angle at the position at a distance of about 5 mm from the center was left-twisted and 80° (−80°), the twisted angle at the position at a distance of about 15 mm from the center was left-twisted and 115° (−115°), and the twisted angle increased toward the outer direction.

As a result, the liquid crystal layer where the twisted angle changed in a plane was formed.

Finally, in the second liquid crystal layer, Δn₅₅₀×thickness (Re(550)) of the liquid crystals was 330 nm, and it was verified using a polarization microscope that concentric circular (radial) periodic alignment occurred on the surface as shown in FIG. 5. This liquid crystal layer had a liquid crystal alignment pattern where the period decreased toward the outer direction. Regarding the twisted angle in the thickness direction of the liquid crystal layer, the twisted angle at the position at a distance of about 5 mm from the center was left-twisted and 6° (−6°), the twisted angle at the position at a distance of about 15 mm from the center was left-twisted and 76° (−76°), and the twisted angle increased toward the outer direction.

As a result, the liquid crystal layer where the twisted angle changed in a plane was formed.

Finally, in the third liquid crystal layer, Δn₅₅₀×thickness (Re(550)) of the liquid crystals was 160 nm, and it was verified using a polarization microscope that concentric circular (radial) periodic alignment occurred on the surface as shown in FIG. 5. This liquid crystal layer had a liquid crystal alignment pattern where the period decreased toward the outer direction. Regarding the twisted angle in the thickness direction of the liquid crystal layer, the twisted angle at the position at a distance of about 5 mm from the center was right-twisted and 80° (twisted angle: 80°), the twisted angle at the position at a distance of about 15 mm from the center was left-twisted and 48° (twisted angle: 48°), and the twisted angle decreased toward the outer direction.

As a result, a liquid crystal layer including the first liquid crystal layer to the third liquid crystal layer was formed.

In a case where a cross section of the prepared optically-anisotropic layer was observed with an SEM, bright portions and dark portions had a shape in which the dark portion had two inflection points and the average tilt angle increased from the center toward the outer direction.

In addition, by causing parallel light to be incident into the liquid crystal diffraction element including the first to third liquid crystal layers, the focal length of focused emitted light was measured. The focal length was 30 mm.

### Example 2-B2

An image display unit was prepared using the same method as that of Example 1-B2, except that during the preparation of the liquid crystal diffraction element, the alignment pattern to be formed on the alignment film P-1 was changed, the focal length was changed to 15 mm, and the distance of the image display apparatus and the liquid crystal diffraction element was changed to 15 mm.

### Example 3-B2

An image display unit was prepared using the same method as that of Example 1-B2, except that during the preparation of the liquid crystal diffraction element, the alignment pattern to be formed on the alignment film P-1 was changed, the focal length was changed to 10 mm, and the distance of the image display apparatus and the liquid crystal diffraction element was changed to 10 mm.

### Example 1-B3

A liquid crystal diffraction element was prepared using the same method as that of Example 1-B1, except that the liquid crystal compound L-1 was changed to a liquid crystal compound L-3, the addition amounts of the chiral agent C-3 and the chiral agent C-4 were adjusted, the irradiation dose of ultraviolet light with which the coating film was irradiated during the preparation of the liquid crystal layer changed from the center portion toward the end part was adjusted to adjust the film thickness of the liquid crystal layer, the heating temperature of the coating film during the formation of the liquid crystal layer was changed to 55° C., and the film thickness of the liquid crystal layer was adjusted, and an image display unit according to Example 1-B3 was prepared using the prepared liquid crystal diffraction element.

Finally, in the first liquid crystal layer, Δn₅₅₀×thickness (Re(550)) of the liquid crystals was 160 nm, and it was verified using a polarization microscope that concentric circular (radial) periodic alignment occurred on the surface as shown in FIG. 5. This liquid crystal layer had a liquid crystal alignment pattern where the period decreased toward the outer direction. Regarding the twisted angle in the thickness direction of the liquid crystal layer, the twisted angle at the position at a distance of about 5 mm from the center was left-twisted and 80° (−80°), the twisted angle at the position at a distance of about 15 mm from the center was left-twisted and 115° (−115°), and the twisted angle increased toward the outer direction.

As a result, the liquid crystal layer where the twisted angle changed in a plane was formed.

Finally, in the second liquid crystal layer, Δn₅₅₀×thickness (Re(550)) of the liquid crystals was 330 nm, and it was verified using a polarization microscope that concentric circular (radial) periodic alignment occurred on the surface as shown in FIG. 5. This liquid crystal layer had a liquid crystal alignment pattern where the period decreased toward the outer direction. Regarding the twisted angle in the thickness direction of the liquid crystal layer, the twisted angle at the position at a distance of about 5 mm from the center was left-twisted and 6° (−6°), the twisted angle at the position at a distance of about 15 mm from the center was left-twisted and 76° (−76°), and the twisted angle increased toward the outer direction.

As a result, the liquid crystal layer where the twisted angle changed in a plane was formed.

Finally, in the third liquid crystal layer, Δn₅₅₀×thickness (Re(550)) of the liquid crystals was 160 nm, and it was verified using a polarization microscope that concentric circular (radial) periodic alignment occurred on the surface as shown in FIG. 5. This liquid crystal layer had a liquid crystal alignment pattern where the period decreased toward the outer direction. Regarding the twisted angle in the thickness direction of the liquid crystal layer, the twisted angle at the position at a distance of about 5 mm from the center was right-twisted and 80° (twisted angle: 80°), the twisted angle at the position at a distance of about 15 mm from the center was left-twisted and 48° (twisted angle: 48°), and the twisted angle decreased toward the outer direction.

As a result, a liquid crystal layer including the first liquid crystal layer to the third liquid crystal layer was formed.

In a case where a cross section of the prepared optically-anisotropic layer was observed with an SEM, bright portions and dark portions had a shape in which the dark portion had two inflection points and the average tilt angle increased from the center toward the outer direction.

In addition, by causing parallel light to be incident into the liquid crystal diffraction element including the first to third liquid crystal layers, the focal length of focused emitted light was measured. The focal length was 30 mm.

### Example 2-B3

An image display unit was prepared using the same method as that of Example 1-B3, except that during the preparation of the liquid crystal diffraction element, the alignment pattern to be formed on the alignment film P-1 was changed, the focal length was changed to 15 mm, and the distance of the image display apparatus and the liquid crystal diffraction element was changed to 15 mm.

### Example 3-B3

An image display unit was prepared using the same method as that of Example 1-B3, except that during the preparation of the liquid crystal diffraction element, the alignment pattern to be formed on the alignment film P-1 was changed, the focal length was changed to 10 mm, and the distance of the image display apparatus and the liquid crystal diffraction element was changed to 10 mm.

[Evaluation]

<Evaluation of Light Utilization Efficiency of Image Display Unit>

The display in the image display unit was removed, and a light source for evaluation was disposed. As the light source for evaluation, a laser pointer (wavelength: 532 nm) was used. Using the laser pointer, light was caused to be incident (incidence light) from the first linearly polarizing plate side, and the intensity of emitted light was measured using a power meter. An intensity ratio between the intensity of the incidence light and the intensity of the emitted light was obtained.

At positions of 5 mm and 15 mm from the center of the concentric circle of the prepared liquid crystal diffraction element, the measurement was performed from the normal direction (0°) of the liquid crystal diffraction element.

Using the measured intensity ratios (light utilization efficiencies), Examples 1 to 3 and Examples 1-B1 to 3-B1 were compared.

As a result of the evaluation, as compared to Example 1, the light utilization efficiency of Example 1-B1 was the same at the position of 5 mm from the center of the concentric circle of the liquid crystal diffraction element, and was improved at the position of 15 mm from the center of the concentric circle of the liquid crystal diffraction element.

Likewise, as compared to Example 2, the light utilization efficiency of Example 2-B1 was the same at the position of 5 mm from the center of the concentric circle of the liquid crystal diffraction element, and was improved at the position of 15 mm from the center of the concentric circle of the liquid crystal diffraction element.

As compared to Example 3, the light utilization efficiency of Example 3-B1 was the same at the position of 5 mm from the center of the concentric circle of the liquid crystal diffraction element, and was improved at the position of 15 mm from the center of the concentric circle of the liquid crystal diffraction element.

It can be seen from the above results that, in the liquid crystal diffraction element having the configuration where the liquid crystal layer has regions having different twisted angles in the thickness direction and, in the region having a shorter single period Λ of the liquid crystal alignment pattern, the twisted angle in the thickness direction of the liquid crystal layer increases (the average tilt angle of the dark portion increases), the light utilization efficiency is improved in the region where the diffraction angle is large (in the above-described case, at the position of 15 mm).

[Evaluation]

<Evaluation of Light Utilization Efficiency of Image Display Unit>

The display in the image display unit was removed, and a light source for evaluation was disposed. As the light source for evaluation, a laser pointer (wavelength: 532 nm) was used. Using the laser pointer, light was caused to be incident (incidence light) from the first linearly polarizing plate side, and the intensity of emitted light was measured using a power meter. An intensity ratio between the intensity of the incidence light and the intensity of the emitted light was obtained.

At positions of 5 mm and 15 mm from the center of the concentric circle of the prepared liquid crystal diffraction element, the measurement was performed while changing the incidence angle of ±40° (at intervals of 10°) from the normal direction (0°) of the liquid crystal diffraction element.

The average values of the intensity ratios (light utilization efficiencies) measured at the different incidence angles were calculated, and Examples 1-B1 to 3-B1, Examples 1-B2 to 3-B2, and Examples 1-B3 to 3-B3 were compared.

As a result of the evaluation, as compared to Example 1-B1, the light utilization efficiency (average value) of Example 1-B2 was improved, and the light utilization efficiency (average value) of Example 1-B3 was further improved.

Likewise, as compared to Example 2-B1, the light utilization efficiency (average value) of Example 2-B2 was improved, and the light utilization efficiency (average value) of Example 2-B3 was further improved.

As compared to Example 3-B1, the light utilization efficiency (average value) of Example 3-B2 was improved, and the light utilization efficiency (average value) of Example 3-B3 was further improved.

It can be seen from the above results that, as the difference Δn₅₅₀ in refractive index of the liquid crystal layer of the liquid crystal diffraction element increases, the light utilization efficiency with respect to the different incidence angles is improved.

### Examples 4 to 6

Image units were prepared using the same preparation method of the image units according to Examples 1 to 3, except that the linearly polarizing plate (polyvinyl alcohol layer type) was changed to an absorptive polarizing plate prepared as described below.

[Preparation of Absorptive Polarizer]

<Preparation of Transparent Support 1>

A coating liquid PA1 for forming an alignment layer described below was continuously applied to a cellulose acylate film (TAC substrate having a thickness of 40 μm; TG 40, manufactured by Fujifilm Corporation) using a wire bar. The support on which the coating film was formed was dried with hot air at 140° C. for 120 seconds. Next, the coating film was irradiated with polarized ultraviolet rays (10 mJ/cm², using an ultra-high pressure mercury lamp) to form a photoalignment layer PA1. As a result, a TAC film with the photoalignment layer was obtained.

The film thickness was 0.3 μm.

(Coating Liquid PA1 for Forming Alignment Layer)

| | | |
|---|---|---|
| The following polymer PA-1 | 100.00 | parts by mass |
| The following acid generator PAG-1 | 5.00 | parts by mass |
| The following acid generator CPI-110TF | 0.005 | parts by mass |
| Xylene | 220.00 | parts by mass |
| Methyl isobutyl ketone | 122.00 | parts by mass |

Polymer PA-1 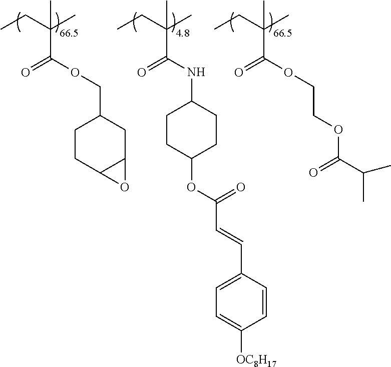
Acid Generator PAG-1 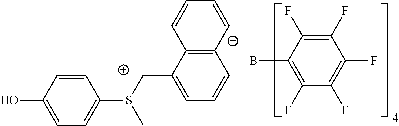
Acid Generator CPI-110F

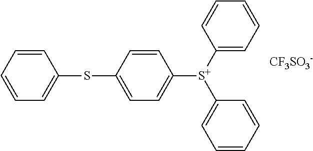

<Formation of Light-Absorption Anisotropic Layer P1>

A composition P1 for forming a light-absorption anisotropic layer described below was continuously applied to the obtained alignment layer PA1 using a wire bar to form a coating layer P1.

Next, the coating layer P1 was heated at 140° C. for 30 seconds and was cooled to room temperature (23° C.).

Next, the coating layer P1 was heated at 90° C. for 60 seconds and was cooled to room temperature.

Next, the coating layer P1 was irradiated with light using a LED light (central wavelength: 365 nm) under irradiation conditions of an illuminance of 200 mW/cm² for 2 seconds to form the light-absorption anisotropic layer P1 on the alignment layer PA1.

The film thickness was 1.6 μm.

As a result, a laminate 1B was obtained.

Composition of Composition Pl for Forming Light-Absorption Anisotropic Layer

| | | |
|---|---|---|
| The following dichroic substance D-1 | 0.25 | parts by mass |
| The following dichroic substance D-2 | 0.36 | parts by mass |
| The following dichroic substance D-3 | 0.59 | parts by mass |
| The following polymer liquid crystal compound P-1 | 2.21 | parts by mass |
| The following low-molecular-weight liquid crystalline compound M-1 | 1.36 | parts by mass |
| Polymerization Initiator | 0.200 | parts by mass |
| IRGACURE OXE-02 (manufactured by BASF SE) | | |
| The following surfactant F-1 | 0.026 | parts by mass |
| Cyclopentanone | 46.0 | parts by mass |
| Tetrahydrofuran | 46.00 | parts by mass |
| Benzyl alcohol | 3.00 | parts by mass |

D-1

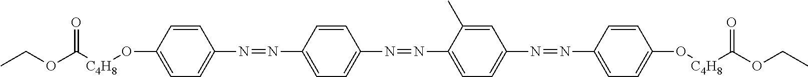

D-2

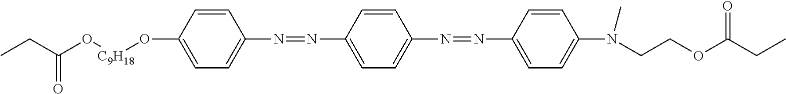

D-3

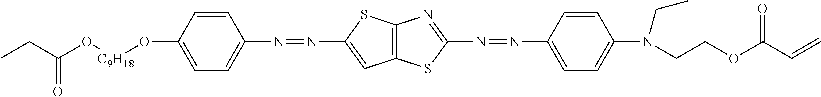

Polymer Liquid Crystal Compound P-1

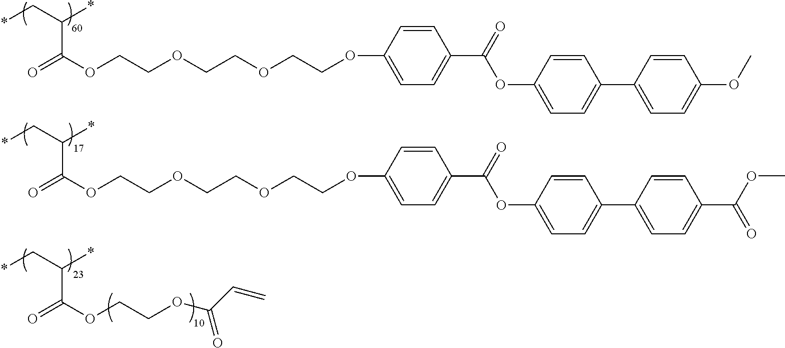

Low-Molecular-Weight Liquid Crystalline Compound M-1

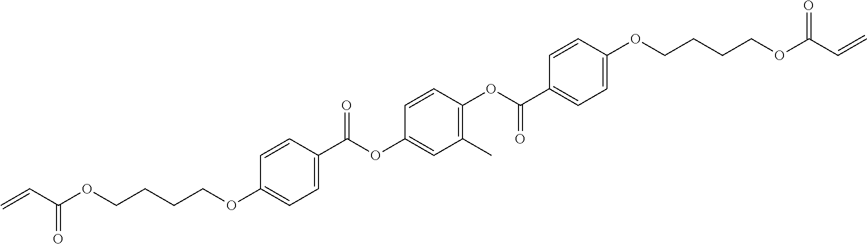 [SMILES: C=CC(=O)OCCCCOc1ccc(C(=O)Oc2ccc(OC(=O)c3ccc(OCCCCOC(=O)C=C)cc3)c(C)c2)cc1]

Surfactant F-1

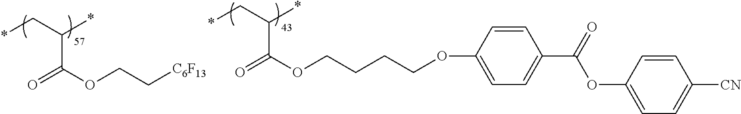

<Preparation of UV Adhesive>
The following UV adhesive composition was prepared.
UV Adhesive Composition

| | | |
|---|---|---|
| CEL2021P (manufactured by Daicel Corporation) | 70 | parts by mass |
| 1,4-butanediol diglycidyl ether | 20 | parts by mass |
| 2-ethylhexyl glycidyl ether | 10 | parts by mass |
| CPI-100P | 2.25 | parts by mass |

CPI-100P

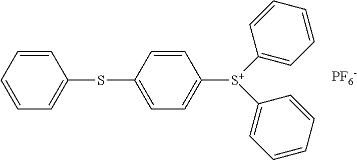

<Preparation of Absorptive Polarizing Film>

TECHNOLLOY S001G (methacrylic resin, thickness: 50 μm, tan δ peak temperature: 128° C., manufactured by Sumika Acryl Co., Ltd.) as a resin substrate S1 was bonded to the surface of the light-absorption anisotropic layer of the laminate 1B using the UV adhesive. Next, only the cellulose acylate film 1 was peeled off, and an absorptive polarizing film in which the resin substrate, the adhesive layer, the light-absorption anisotropic layer, and the alignment layer were disposed in this order was prepared. The thickness of the UV adhesive layer was 2 μm.

The arithmetic average roughness Ra of the obtained absorptive polarizing film was 10 nm or less. On the other hand, the arithmetic average roughness Ra of the linearly polarizing plate (polyvinyl alcohol layer type) was 20 nm or more.

As a result, the prepared absorptive polarizing film can suppress distortion of a displayed image.

The arithmetic average roughness Ra was measured using an interferometer “Vertscan” (manufactured by Mitsubishi Chemical Systems Inc.).

[Evaluation]

In the evaluation of the light utilization efficiency of the image display unit, the image quality evaluation 1, and the image quality evaluation 2, the results were all A.

As can be seen from the above results, the effects of the present invention are obvious.

### EXPLANATION OF REFERENCES

10a, 10b: image display unit
12: first linearly polarizing plate
14: first retardation plate
16: first circularly polarizing plate
20: polarization diffraction element (polarization diffraction lens)
22: second retardation plate
24: second linearly polarizing plate
26: second circularly polarizing plate
30: support
32: alignment film
36: liquid crystal layer
40: liquid crystal compound
40A: optical axis
42: bright portion
44: dark portion
52, 52b: image display apparatus
80: exposure device
82: laser
84: light source
86, 94: polarization beam splitter
90A, 90B: mirror
96: λ/4 plate
92: lens
D, A₁ to A₃: arrangement axis
Λ: single period
U: user
M: laser light
MP: P polarized light
MS: S polarized light
R: region
L₁, L₂, L₄, L₅: light
VI: virtual image
d: distance between image display apparatus and polarization diffraction lens
f: focal length of polarization diffraction lens

What is claimed is:

1. An image display unit comprising:
an image display apparatus;
a polarization diffraction element that diffracts light emitted from the image display apparatus; and
a polarizing plate that allows transmission of the polarized light diffracted by the polarization diffraction element and absorbs light not diffracted by the polarization diffraction element,
wherein the polarization diffraction element is a polarization diffraction lens having a lens function, and
in a case where a focal length of the polarization diffraction lens is represented by f and a distance between the image display apparatus and the polarization diffraction lens is represented by d,
d≤f is satisfied.

2. The image display unit according to claim 1,
wherein the focal length f of the polarization diffraction lens is less than 40 mm.

3. The image display unit according to claim 1,
wherein the polarization diffraction element diffracts circularly polarized light, and
the polarizing plate is a circularly polarizing plate.

4. The image display unit according to claim 3,
wherein the image display apparatus emits linearly polarized light, and
a retardation plate is provided between the image display apparatus and the polarization diffraction element.

5. The image display unit according to claim 4,
wherein the retardation plate is a λ/4 plate.

6. The image display unit according to claim 3,
wherein the image display apparatus emits unpolarized light, and
the circularly polarizing plate is provided between the image display apparatus and the polarization diffraction element.

7. The image display unit according to claim 3,
wherein the circularly polarizing plate consists of a linearly polarizing plate and a retardation plate.

8. The image display unit according to claim 7,
wherein the retardation plate is a λ/4 plate.

9. The image display unit according to claim 1,
wherein the polarization diffraction element is a liquid crystal diffraction element that includes a liquid crystal layer including a liquid crystal compound,
the liquid crystal layer has a liquid crystal alignment pattern in which a direction of an optical axis derived from the liquid crystal compound changes while continuously rotating in at least one in-plane direction, and
in a case where a length over which the direction of the optical axis derived from the liquid crystal compound in the liquid crystal alignment pattern rotates by 180° in an in-plane direction is set as a single period, the liquid crystal layer has regions where lengths of the single periods are different from each other in a plane.

10. The image display unit according to claim 9,
wherein in the liquid crystal layer, the single period gradually decreases in a direction from one side to another side of the liquid crystal alignment pattern in the one in-plane direction.

11. The image display unit according to claim 9,
wherein the liquid crystal layer has a concentric circular shape in which the one in-plane direction of the liquid crystal alignment pattern moves from an inner side toward an outer side.

12. The image display unit according to claim 9,
wherein in a cross sectional image obtained by observing a cross section of the liquid crystal layer taken in a thickness direction parallel to the one in-plane direction with a scanning electron microscope, the liquid crystal layer has regions where bright portions and dark portions derived from a liquid crystal phase are tilted with respect to a main surface of the liquid crystal layer.

13. The image display unit according to claim 12,
wherein the liquid crystal diffraction element includes two or more liquid crystal layers,
in cross sectional images obtained by observing cross sections of at least two of the liquid crystal layers taken in a thickness direction parallel to the one in-plane direction with a scanning electron microscope, bright portions and dark portions derived from the direction of the optical axis are observed, and
in the at least two liquid crystal layers, tilt angles of the bright portions and the dark portions with respect to the main surface of the liquid crystal layer are different from each other.

14. The image display unit according to claim 9,
wherein in a cross sectional image obtained by observing a cross section of the liquid crystal layer taken in a thickness direction parallel to the one in-plane direction with a scanning electron microscope, the liquid crystal layer has bright portions and dark portions extending from one surface to another surface and each of the dark portions has two or more inflection points of angle, and
the liquid crystal layer has regions where tilt directions of the dark portions are different from each other in the thickness direction.

15. The image display unit according to claim 14,
wherein in the liquid crystal layer, the number of inflection points where the tilt direction of the dark portion is folded is an odd number.

16. The image display unit according to claim 12,
wherein in the liquid crystal layer, an average tilt angle of the dark portion gradually changes in the one in-plane direction.

17. The image display unit according to claim 12,
wherein the liquid crystal layer has a region where shapes of the bright portions and the dark portions are asymmetrical with respect to a center line of the liquid crystal layer in the thickness direction.

18. The image display unit according to claim 9,
wherein a difference Δn₅₅₀ in refractive index generated by refractive index anisotropy of the liquid crystal layer is 0.2 or more.

19. A head-mounted display comprising:
the image display unit according to claim 1.

20. The image display unit according to claim 2,
wherein the polarization diffraction element diffracts circularly polarized light, and
the polarizing plate is a circularly polarizing plate.
